(19) United States
(12) Patent Application Publication
(10) Pub. No.: US 2012/0315191 A1
(43) Pub. Date: Dec. 13, 2012

(54) MICROCHANNEL CHIP AND MICROARRAY CHIP

(75) Inventors: Akira Maekawa, Hitachinaka (JP); Satoshi Takahashi, Hitachinaka (JP)

(73) Assignee: Hitachi-High-Technologies Corporation

(21) Appl. No.: 13/579,937

(22) PCT Filed: Feb. 25, 2011
(86) PCT No.: PCT/JP2011/054242

§ 371 Date: Aug. 19, 2012

(30) Foreign Application Priority Data
Mar. 23, 2010 (JP) 2010-065396
Sep. 3, 2010 (JP) 2010-197992

(51) Int. Cl. G01N 21/64; B21D 51/16; B01L 3/00

(52) U.S. Cl. 422/82.08; 422/502; 29/890.09

(57) ABSTRACT

A microchannel chip is provided that is easily mountable irrespective of limitation of arrangement of devices therearound and relatively inexpensive in manufacturing cost. The microchannel chip includes: a substrate holder including a recess; a reaction substrate mounted in the recess of the substrate holder; a first sheet disposed so as to cover the substrate holder and the reaction substrate; and a second sheet disposed so as to cover the first sheet. The reaction substrate includes: a first surface exposed to the reaction chamber; and a second surface exposed to the outside through an observation window provided on the recess of the substrate holder. A reaction spot including a microstructure is formed on the first surface of the reaction substrate. The reaction spot is exposed to the reaction chamber.

### TECHNICAL FIELD

The present invention relates to a microchannel chip and a microarray chip that are suitable to be used for nucleic acid analyzers, such as a genetic diagnostic device and a genetic analyzer.

### BACKGROUND ART

In recent years, a method has been proposed that, in a nucleic acid analyzer, immobilizes many DNA probes or polymerases onto a reaction substrate made of a glass substrate and causes base extension reaction to thereby determine the sequence. A region for such fixation and reaction is hereinafter referred to as “reaction spot”. Methods for forming a reaction spot include a case of immobilizing a single molecule (single molecule method) and a case of immobilizing multiple molecules of the same type (multiple molecule method). Furthermore, a super-parallel nucleic acid analyzer has been developed that arranges many reaction spots and causes base extension and determine the sequence in parallel at each reaction spot.

Non Patent Literature 1 describes a method that immobilizes a single molecule at a reaction spot and reads a DNA sequence at a single molecular level using a total reflection evanescent illumination detection method. Patent Literature 1 describes measurement of base extension reaction using fluorescence enhancement effect of localized surface plasmons. Patent Literatures 2 and 3 describe examples of methods of manufacturing microchannel chip using polydimethylsiloxane (PDMS) substrates or sheets. Patent Literature 4 describes a method of analyzing a sample, which is a PCR product, using a nanochip. Patent Literatures 5 and 6 describe examples of measurement using a microchannel chip including an inlet and an outlet.

### CITATION LIST

### Patent Literature

Patent Literature 1: JP Patent Publication (Kokai) No. 2009-45057 A
Patent Literature 2: JP Patent Publication (Kokai) No. 2009-47438 A
Patent Literature 3: JP Patent Publication (Kokai) No. 2005-111567 A
Patent Literature 4: JP Patent Publication (Kokai) No. 2005-181145 A
Patent Literature 5: JP Patent Publication (Kokai) No. 2005-245317 A
Patent Literature 6: JP Patent Publication (Kokai) No. 2005-233802 A

### Non Patent Literature

Non Patent Literature 1: Ido Braslaysky, “Proc. Natl. Acad. Sci. USA”, 2003, Vol. 100, No. 7, pp. 3960-3964

### SUMMARY OF INVENTION

### Technical Problem

A microchannel chip is mounted on a nucleic acid analyzer or the like, and connected with a system of supplying a solution or the like and a system of discharging a liquid waste. It is preferred that the microchannel chip have a configuration to which the solution supply system and the liquid waste discharge system can easily be connected. Furthermore, an illumination device and a detection device are arranged on both or one of the surfaces of the microchannel chip. For instance, in the case of observation with a high magnification objective lens, it is required to bring the objective lens into proximity to the microchannel chip. Accordingly, it is preferred that the microchannel chip match with an illumination device and a detection device having any structure.

The microchannel chip includes a reaction substrate equipped with a reaction spot. Since reaction substrates are made using a semiconductor manufacturing process, the substrates are relatively expensive. It is preferred that reaction substrates have a size as small as possible. Ideally, the dimensions are equivalent to a region where a reaction spot for observation is disposed, which eliminates waste.

It is an object of the present invention to provide a microchannel chip that is easily mountable irrespective of limitation of arrangement of devices therearound and relatively inexpensive in manufacturing cost.

### Solution to Problem

A microchannel chip according of the present invention includes: a reaction chamber; an inlet and an outlet; and a supply channel and a discharge channel that cause the reaction chamber to communicate with the inlet and the outlet, respectively.

The microchannel chip according of the present invention includes: a substrate holder including a recess; a reaction substrate mounted in the recess of the substrate holder; a first sheet disposed so as to cover the substrate holder and the reaction substrate; and a second sheet disposed so as to cover the first sheet. The microchannel chip of the present invention includes: a reaction substrate; a first sheet that is larger than the reaction substrate, and at least includes a through-hole or a recess at a position corresponding to a reaction chamber; and a second sheet adhering to the first sheet.

According to the microchannel chip of the present invention, the reaction substrate, the through-hole in the first sheet and the second sheet form the reaction chamber, or the reaction substrate and the recess of the first sheet form the reaction chamber. The inlet and the outlet are disposed apart from and at the outside of the reaction substrate. A channel that causes the reaction chamber to communicate with the inlet and the outlet is formed between the first sheet and the second sheet.

### Advantageous Effects of Invention

The present invention can provide a microchannel chip that is easily mountable irrespective of limitation of arrangement of devices therearound and relatively inexpensive in manufacturing cost.

### BRIEF DESCRIPTION OF DRAWINGS

FIG. 1A is a diagram showing an example (Embodiment 1) of the configuration of a microchannel chip of the present invention.

FIG. 1B is a diagram showing an example of a channel sheet of the microchannel chip of the present invention.

FIG. 1C is a diagram showing an example of a reaction chamber sheet of the microchannel chip of the present invention.

FIG. 1D is a diagram showing an example of a substrate holder of the microchannel chip of the present invention.

FIG. 1E is a diagram showing an example of a reaction substrate of the microchannel chip of the present invention.

FIG. 2 is a diagram illustrating a main part of a DNA sequencer using the microchannel chip of the present invention.

FIG. 3 is a diagram illustrating a single molecule DNA sequencer using the microchannel chip of the present invention.

FIG. 4 is a diagram illustrating an example of a single molecule DNA sequence analysis method using the microchannel chip of the present invention.

FIG. 5A is a diagram showing an example (Embodiment 2) of the configuration of a microarray chip of the present invention.

FIG. 5B is a diagram showing an example of a channel sheet of the microarray chip of the present invention.

FIG. 5C is a diagram showing an example of a substrate holder of the microarray chip of the present invention.

FIG. 5D is a diagram showing an example of a reaction substrate of the microarray chip of the present invention.

FIG. 6A is a diagram illustrating a method of mounting the microarray chip of the present invention on a genetic analyzer.

FIG. 6B is a diagram illustrating a method of mounting the microarray chip of the present invention on the genetic analyzer.

FIG. 7 is a diagram illustrating an example of the configuration of a genetic analysis system using the microarray chip of the present invention.

FIG. 8 is a diagram illustrating an example of a method of operating the genetic analysis system using the microarray chip of the present invention.

FIG. 9A is a diagram showing another example (Embodiment 3) of the configuration of a microchannel chip of the present invention.

FIG. 9B is a plan view of a sheet 2 of the microchannel chip of the present invention in FIG. 9A.

FIG. 9C is a plan view of a sheet 1 of the microchannel chip of the present invention in FIG. 9A.

FIG. 9D is a plan view of a substrate holder of the microchannel chip of the present invention in FIG. 9A.

FIG. 10A is a diagram showing another example (Embodiment 4) of the configuration of the microchannel chip of the present invention.

FIG. 10B is a plan view of a substrate holder of the microchannel chip of the present invention in FIG. 10A.

FIG. 11A is a diagram showing another example (Embodiment 5) of the configuration of a microchannel chip of the present invention.

FIG. 11B is a plan view of a sheet 2 of the microchannel chip of the present invention in FIG. 11A.

FIG. 11C is a plan view of a sheet 1 of the microchannel chip of the present invention in FIG. 11A.

FIG. 11D is a plan view of a sheet 3 of the microchannel chip of the present invention in FIG. 11A.

FIG. 11E is a plan view of a substrate holder of the microchannel chip of the present invention in FIG. 11A.

FIG. 12A is a diagram showing another example (Embodiment 6) of the configuration of a microchannel chip of the present invention.

FIG. 12B is a plan view of a sheet 2 of the microchannel chip of the present invention in FIG. 12A.

FIG. 12C is a plan view of a sheet 1 of the microchannel chip of the present invention in FIG. 12A.

FIG. 12D is a plan view of a substrate holder of the microchannel chip of the present invention in FIG. 12A.

FIG. 13A is a diagram showing another example (Embodiment 7) of the microchannel chip of the present invention.

FIG. 13B is a plan view of a sheet 2 of the microchannel chip of the present invention FIG. 13A.

FIG. 13C is a plan view of a sheet 1 of the microchannel chip of the present invention in FIG. 13A.

FIG. 13D is a plan view of a substrate holder of the microchannel chip of the present invention in FIG. 13A.

FIG. 14A is a plan view of another example (Embodiment 8) of the configuration of a sheet 1 of a microchannel chip of the present invention.

FIG. 14B is a plan view of another example (Embodiment 8) of the configuration of the microchannel chip of the present invention.

FIG. 15A is a diagram showing another example (Embodiment 9) of the configuration of the microchannel chip of the present invention.

FIG. 15B is a plan view of a sheet 2 of the microchannel chip of the present invention in FIG. 15A.

FIG. 15C is a plan view of a sheet 1 of the microchannel chip of the present invention in FIG. 15A.

FIG. 15D is a plan view of a sheet 3 of the microchannel chip of the present invention in FIG. 15A.

FIG. 15E is a plan view of a substrate holder of the microchannel chip of the present invention in FIG. 15A.

### DESCRIPTION OF EMBODIMENTS

### Embodiment 1

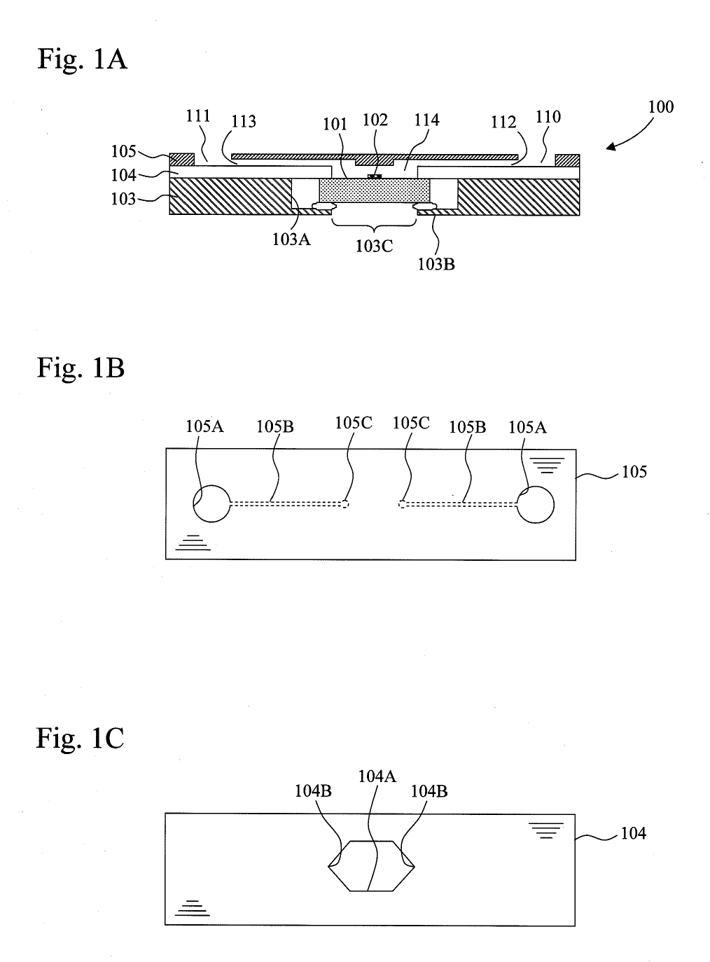

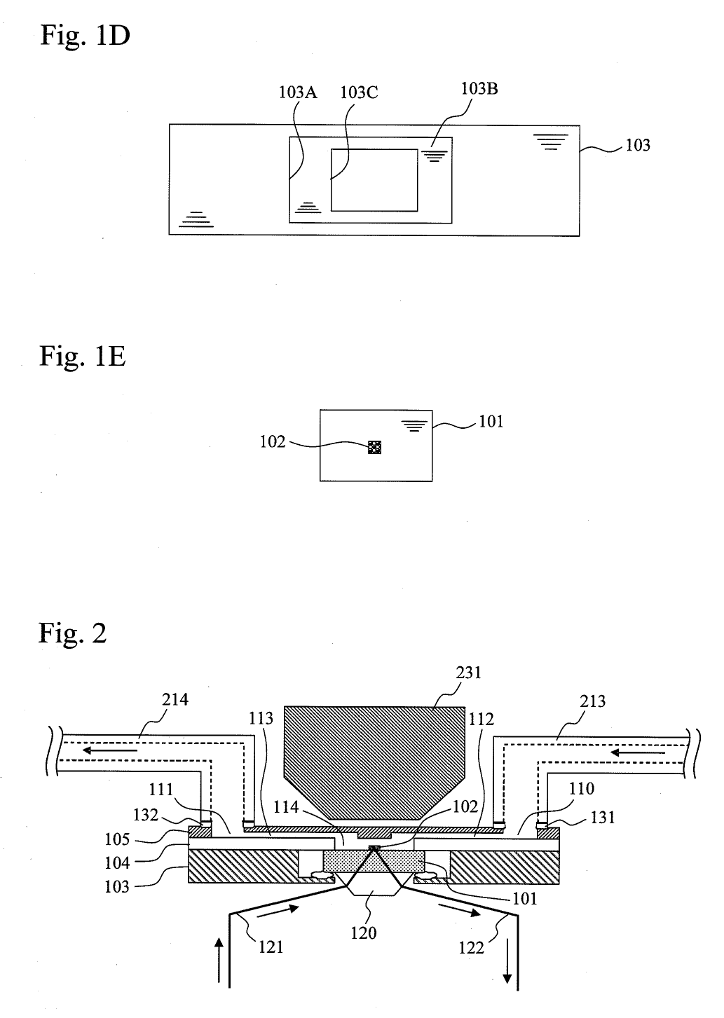

Referring to FIGS. 1A, 1B, 1C, 1D and 1E, a first embodiment of a microchannel chip according to the present invention will be described. As shown in FIG. 1A, the microchannel chip of this embodiment includes a substrate holder 103, a reaction substrate 101 mounted on the substrate holder 103, a reaction chamber sheet 104 disposed so as to cover the substrate holder 103 and the reaction substrate 101, and a channel sheet 105 disposed further thereon. Between two main surfaces of each of the reaction substrate 101, the substrate holder 103, the reaction chamber sheet 104 and the channel sheet 105, the upper surface in FIGS. 1A, 1B, 1C, 1D and 1E is referred to as a top surface, and the lower surface is referred to as an undersurface.

A reaction spot 102 is formed on the top surface of the reaction substrate 101. The reaction spot 102 is a region where many DNA probes or polymerases are immobilized to cause base extension reaction and the like. An illumination window 103C is formed on the undersurface of the microchannel chip. The undersurface of the reaction substrate 101 is exposed through the illumination window 103C. In a sectional view of FIG. 1A, as to the microchannel chip of this embodiment, the reaction spot 102 is irradiated with illumination light from the bottom through the illumination window 103C. The reaction spot 102 is observed through the channel sheet 105. Accordingly, the channel sheet 105, the reaction chamber sheet 104 and the reaction substrate 101 are formed of transparent material.

The microchannel chip includes an inlet 110, a supply channel 112, a reaction chamber 114, a discharge channel 113 and an outlet 111. The supply channel 112, the reaction chamber 114 and the discharge channel 113 sequentially communicate with each other to form a closed channel. The inlet 110 and the outlet 111 are formed at positions at least 30 mm apart from the reaction spot 102 so as not to obstruct arrangement of an objective lens of a microscope and excitation light source optical system elements.

As shown in FIG. 1E, the reaction substrate 101 is made of a thin plate-like square member having a thickness of about 0.7 mm and a dimension of a side of the square of about 10 mm. It is preferred that the reaction substrate 101 be a plate-like square member having a dimension of a side of 20 mm or less. Furthermore, this substrate may be a plate-like square member having a dimension of a side of 5 to 500 mm. Furthermore, the reaction substrate 101 may be plate-like member having a shape other than a square, for instance, a rectangular, polygonal or circular shape.

The reaction substrate 101 may be formed of quartz. The reaction spot 102 for analyzing genetic sequences, genetic polymorphism or the like is formed on the top surface of the reaction substrate 101.

It is preferred that the reaction spot 102 have a microstructure to facilitate occurrence of localized surface plasmons. Localized surface plasmons exert an effect of locally increasing fluorescence. A range where the effect is exerted is an ultra-small region, which is an extent from 10 nm to 20 nm. A target DNA molecule is immobilized in such an ultra-small region. A fluoresceinated primer single molecule is coupled to the target DNA molecule. This allows only fluorescence from the primer single molecule to be locally increased. Fluorescence from a primer single molecule suspended therearound is insusceptible to a fluorescence increase effect of localized surface plasmons. Accordingly, both molecules can be sharply discriminated.

Patent Literature 1 describes an example of forming a microstructure facilitating occurrence of localized surface plasmons. According to the example described in this literature, a semiconductor manufacturing process forms a microstructure on a wafer. First, the semiconductor manufacturing process, such as metal evaporation, etching, spattering or milling, is performed on a circular quartz substrate (wafer), thereby generating reaction spots. The wafer on which many reaction spots are formed is diced to form reaction substrates 101 having prescribed dimensions. The reaction substrate 101 is more expensive than other parts configuring a microchannel chip. Accordingly, it is preferred that the dimensions of the reaction substrate 101 be as small as possible. According to the present invention, the reaction substrate 101 is configured to be accommodated in a recess 103A of the substrate holder 103, which allows the dimensions of the reaction substrate 101 to be relatively smaller. This enables the price of a microchannel chip to be suppressed.

As shown in FIG. 1D, the recess 103A for accommodating the reaction substrate 101 is formed on the top surface of the substrate holder 103. A through-hole is formed on the bottom surface of the recess 103A. This through-hole forms the illumination window 103C of the microchannel chip. That is, the undersurface of the reaction substrate 101 is exposed at the illumination window 103C of the microchannel chip. Members around the illumination window 103C form the reaction substrate holding section 103B for holding the reaction substrate. The longitudinal and lateral dimensions of the illumination window 103C are smaller than the longitudinal and lateral dimensions of the reaction substrate 101. Accordingly, the reaction substrate holding section 103B can support the reaction substrate 101.

The substrate holder 103 has dimensions equivalent to those of a typical slide glass. More specifically, the longitudinal and lateral dimensions are 26 mm×76 mm. The thickness is preferably about 2 mm, but may be 0.1 mm to 10 mm. The longitudinal and lateral dimensions of recess 103A are larger than the longitudinal and lateral dimensions of the reaction substrate. The depth of the recess 103A is identical to or larger than the thickness of the reaction substrate 101. The thickness of the reaction substrate holding section 103B is preferably about 0.5 mm, but may be 0.01 mm to 5 mm.

The substrate holder 103 is made of a material resistant to unintentional handling errors and dropping by users. This material is any of metals, such as stainless steel, aluminum and iron, and resins, such as plastic and elastomer.

As shown in FIG. 1C, the reaction chamber sheet 104 has a shape and dimensions equivalent to those of the external shape of the substrate holder 103. A through-hole 104A is formed at the center of the reaction chamber sheet 104. The through-hole 104A forms the reaction chamber 114 of the microchannel chip. That is, the shape of the reaction chamber 114 is identical to the shape of the through-hole 104A.

In this embodiment, the through-hole 104A has a shape that can be acquired by extending a hexagon in the longitudinal direction of the reaction chamber sheet. The corners at opposite ends 104B of the through-hole 104A are disposed along the central axis of the reaction chamber sheet 104. It is preferred that the through-hole 104A have a pointed shape at the opposite ends 104B on the central axis. This can prevent liquid flowing into the reaction chamber 114 from being left resident at the corners of the opposite ends. However, the shape of the through-hole 104A shown in the drawing is only an example. The shape may be a rhombus, an ellipse, a circle, a polygon, a rectangle or the like.

The dimensions of the through-hole 104A are larger than those of the reaction spot 102 but smaller than those of the reaction substrate 101. Accordingly, the bottom surface of the reaction chamber 114 is formed of the top surface of the reaction substrate 101 exposed at the through-hole 104A. A region that can be observed by a detection optical system at one time is hereinafter referred to as a “measurement visual field”. The bottom surface of the reaction chamber 114 has dimensions at least equivalent to or larger than those of the measurement visual field. Accordingly, the dimensions of the through-hole 104A are equivalent to or larger than the dimensions of the measurement visual field.

The thickness of the reaction chamber sheet 104 is preferably 50 μm but may be 5 μm to 5 mm. The reaction chamber sheet is formed of a material resistant to heat, cold, weather and chemicals. It is preferred that such a material be polydimethylsiloxane (PDMS). Since PDMS has self-adhesion, PDMS has an advantage capable of adhering to another member with no adhesive. Surface treatment in conformity with use can be applied to PDMS. This allows PDMS to be provided with hydrophobicity, hydrophilicity and self-adhesion. However, a material other than PDMS can be adopted provided that the material has self-adhesion, is capable of adhesion by photochemical reaction and does not impede reagents and an experimental system to be used. For instance, silicone resin, polyvinyl chloride (PVC) or the like may be adopted.

As shown in FIG. 1B, the channel sheet 105 has a shape and dimensions equivalent to those of the external shape of the substrate holder 103. Two through-holes 105A are formed on the channel sheet 105 along the central axis. The through-holes 105A have a circular shape, and are formed near the respective opposite ends of the channel sheet 105. Two grooves 105B are formed on the undersurface of the channel sheet 105. These grooves extend from the respective through-holes 105A toward the center along the central axis of the substrate holder 103. Recesses 105C having a small circular shape are formed at the other ends of the respective grooves.

The depth of the groove 105B is about 50 μm, and the width is about 500 μm. The depth of the recess 105C may be identical to the depth of the groove 105B. The diameter of the recess 105C may be identical to the width of the groove 105B. Instead, this diameter may be larger than the width of groove.

The two through-holes 105A form the inlet 110 and the outlet 111 of the microchannel chip. The two grooves 105B form the supply channel 112 and the discharge channel 113 of the microchannel chip.

As described above, the inlet 110 and the outlet 111 are formed at the positions about 30 mm apart from the reaction spot so as not to obstruct arrangement of the objective lens of the microscope and the excitation light source optical system elements. Accordingly, the two through-holes 105A are formed at the positions at least 30 mm apart from the center of the channel sheet 105. The recesses 105C at the inner ends of the two grooves 105B are formed at positions that correspond to the respective opposite ends 104B of the through-holes 104A of the reaction chamber sheet 104 and inner than the through-holes 104A.

The thickness of the channel sheet 105 is preferably 100 μm but may be 5 μm to 10 mm. As with the reaction chamber sheet, the channel sheet 105 is formed of a material resistant to heat, cold, weather and chemicals. It is preferred that such a material be polydimethylsiloxane (PDMS). Since PDMS has self-adhesion, PDMS has an advantage capable of adhering to another member with no adhesive. For instance, both the channel sheet 105 and the reaction chamber sheet 104 are made of PDMS, thereby allowing both sheets to be joined to each other using self-adhesion. Thus, a joining process using an adhesive for forming a channel can be eliminated. The description will hereinafter be made provided that both the channel sheet 105 and the reaction chamber sheet are formed of PDMS.

A method of assembling the microchannel chip of this embodiment will now be described. First, the reaction substrate 101 is disposed in the recess 103A of the substrate holder 103. At this time, the disposition is made such that the top surfaces of the substrate holder 103 and the reaction substrate 101 are coplanar with each other. The dimensions of the reaction substrate 101 are larger than the dimensions of the illumination window 103C of the substrate holder 103. Accordingly, the reaction substrate 101 blocks the illumination window 103C. The undersurface of the reaction substrate 101 is exposed at the illumination window 103C. Next, the reaction substrate 101 is caused to adhere to the reaction substrate holding section 103B of the substrate holder. An adhesion method may be by means of an adhesive. However, the method may be by means of welding. Next, the reaction chamber sheet 104 is attached to the top surface of the substrate holder 103. In this embodiment, the reaction chamber sheet 104 is made of PDMS. Accordingly, the self-adhesion of PDMS allows the reaction chamber sheet 104 to adhere onto the top surfaces of the substrate holder 103 and the reaction substrate 101. The dimensions of the through-hole 104A of the reaction chamber sheet 104 are smaller than the dimensions of the reaction substrate 101. Accordingly, no gap is formed between the reaction chamber sheet 104 and the reaction substrate 101 around the through-hole 104A.

Next, the channel sheet 105 is further mounted on the reaction chamber sheet 104. In this embodiment, the reaction chamber sheet 104 and the channel sheet 105 are made of PDMS. Accordingly, the self-adhesion of PDMS allows the channel sheet 105 and the reaction chamber sheet 104 to adhere onto each other. Thus, the microchannel chip is formed. In the thus formed microchannel chip, the reaction chamber 114 is formed in which the channel sheet 105 is the ceiling surface, the reaction substrate 101 is the bottom surface, and the through-hole of the reaction chamber sheet 104 is the side surface. Furthermore, the supply channel 112 and the discharge channel 113 are formed in which the grooves 105B of the channel sheet 105 are channels and the reaction chamber sheet 104 is the bottom surface.

In this embodiment, the grooves 105B are formed on the channel sheet 105. However, equivalent grooves may be formed on the reaction chamber sheet 104 instead of the channel sheet 105.

As to the characteristics of the microchannel chip, the reaction substrates 101 having various reaction spots can be adopted according to analysis targets and analysis methods, but elements other than the reaction substrate 101 are commonly adopted, that is, these elements are identical. Accordingly, volume production can reduce the cost of manufacturing the microchannel chips.

Referring to FIG. 2, a main part of a DNA sequencer using the microchannel chip of the present invention will now be described. The structure of the microchannel chip is equivalent to that shown in FIG. 1A. First, systems for supplying and discharging a reagent will be described. The inlet 110 of the microchannel chip communicates with an inlet tube 213 through a packing 131. The outlet 111 of the microchannel chip communicates with an outlet tube 214 through a packing 132. The packings 131 and 132 are formed of rubber, silicone, PDMS or the like.

An excitation light source optical system and a detection optical system will now be described. FIG. 2 only shows an objective lens 231 as the detection optical system. This embodiment uses a total reflection evanescent illumination detection method for the excitation light source optical system. A total reflection prism 120 is mounted on the undersurface of the reaction substrate 101. The total reflection prism 120 includes a bottom surface that has a square shape with a side of a several centimeters, and side surfaces inclined to the bottom surface. The total reflection prism 120 may be joined to the undersurface of the reaction substrate 101. The total reflection prism 120 may be joined with an adhesive, but is preferably joined by oil immersion. The total reflection prism 120 is mounted on a part exposed at the illumination window in the undersurface of the reaction substrate 101.

Excitation laser light guided along the incident optical path 121 is incident on one inclined surface of the total reflection prism 120, and reaches the top surface of the reaction substrate 101. The excitation laser light is totally reflected by the top surface of the reaction substrate 101, emitted from the other inclined surface of the total reflection prism 120, and guided along the emission optical path 122. The reaction chamber 114 is formed on the reaction substrate 101. Accordingly, the top surface of the reaction substrate 101 is a refractive index boundary. When the light is totally reflected by the refractive index boundary, electromagnetic waves travel into a low medium by about one wavelength of the incident light. This light is referred to as evanescent light. Only a significantly limited region including a metal structure formed at the reaction spot 102 is illuminated with the evanescent light. This illumination is referred to as total reflection evanescent illumination. The region irradiated with the evanescent light is referred to as an evanescent field.

The optical system of this embodiment further uses a fluorescence enhancement effect of localized surface plasmons. As described above, the microstructure is formed at the reaction spot 102 so as to facilitate occurrence of localized surface plasmons. Occurrence of localized surface plasmons at the microstructure of the reaction spot 102 increases fluorescence at an ultra-small region including the microstructure.

A hybridization reaction couples a fluoresceinated single primer molecule to the reaction spot 102. Furthermore, a base extension reaction captures a fluoresceinated dNTP molecule (N is any of A, C, G and T). These fluorochromes emit evanescent light as excitation light. The light emitted from these fluorochromes is locally increased by the localized surface plasmons. The emitted light is detected by the detection optical system including an objective lens 231 disposed above the reaction substrate 101.

Suspended primer molecules and dNTP molecules are out of the evanescent field. Accordingly, these molecules do not emit fluorescence due to evanescent light. The suspended molecules do not receive an effect of increasing fluorescence owing to the localized surface plasmons. Accordingly, the position of single molecule coupled by the hybridization reaction or base extension reaction can be accurately detected.

In the microchannel chip according to the present invention, the inlet 110 and the outlet 111 are arranged on the upper side of the microchannel chip, that is, the side opposite to the illumination window 103C. This arrangement acquires the following advantages. First, the outlet tube 214 and the inlet tube 213 can be disposed on the upper side of the microchannel chip. That is, the outlet tube 214 and the inlet tube 213 can be disposed on the side opposite to the excitation light source optical system. Accordingly, the detection optical system can be disposed on the upper side of the microchannel chip, and the excitation light source optical system can be disposed on the lower side of the microchannel chip. Furthermore, a space for the excitation light source optical system can be secured. This increases flexibility to design the excitation light source optical system. For instance, the total reflection evanescent illumination detection method can be adopted as the excitation light source optical system. As to the total reflection evanescent illumination detection method, the total reflection prism 120 is adopted. In this embodiment, the total reflection prism 120 can be directly mounted on the undersurface of the reaction substrate. Furthermore, the total reflection evanescent illumination detection method requires that the incident light and the reflected light on and by the total reflection prism 120 be guided along respective separate optical paths. This embodiment can easily separate the incident optical path 121 and the emission optical path 122 from each other.

Furthermore, in the microchannel chip of the present invention, the inlet 110 and the outlet 111 are disposed near the respective opposite ends of the microchannel chip. This disposition can acquire the following advantages. A space for the detection optical system can be secured between the outlet tube 214 and the inlet tube 213. This increases flexibility to design the detection optical system. For instance, use of an objective lens for a microscope with a magnification of 40, 60 or 100 times requires a close distance from the top surface of the microchannel chip to the distal end of the objective lens, which is about 0.2 mm. This embodiment can dispose the objective lens in proximity to the microchannel chip, thereby enabling an objective lens having a large aperture, that is, high N/A to be used. This allows the detection sensitivity to be improved.

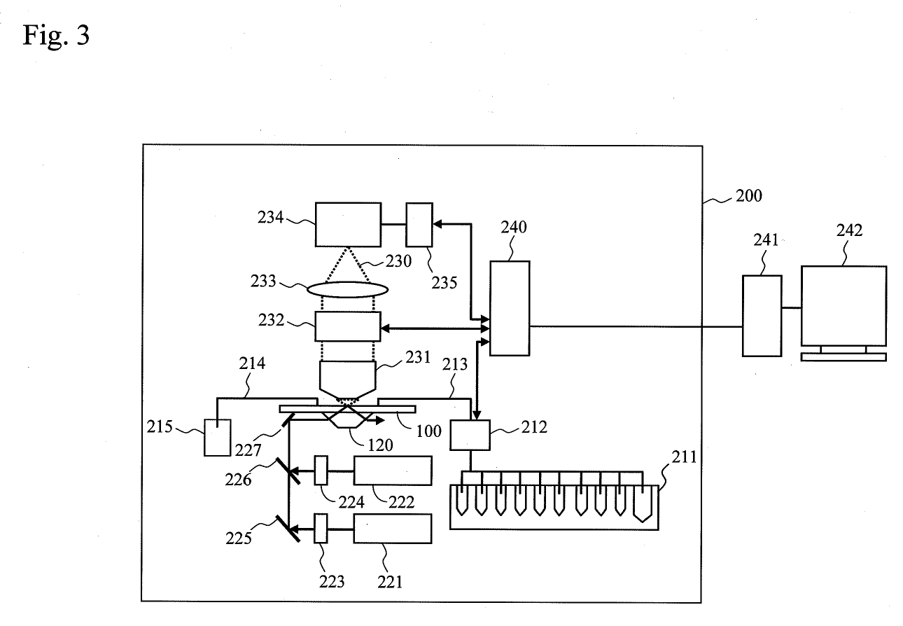

Referring to FIG. 3, an example of a single molecule DNA sequencer will now be described. The DNA sequencer of this embodiment includes an analyzer 200, an analysis computer 241 and an output device 242. The analyzer 200 includes: a detection optical system provided above the microchannel chip 100; an excitation light source optical system provided below the microchannel chip 100; a solution supply system provided at the right of the microchannel chip 100; a liquid waste collection system provided at the left of the microchannel chip 100; and a device control computer 240. The device control computer 240 is connected to the analysis computer 241.

The detection optical system includes the objective lens 231, a fluorescent wavelength filter 232, an imaging lens 233, a two-dimensional sensor camera (detector) 234 and a camera controller (detector controller) 235. The excitation light source optical system includes first and second laser units 221 and 222 for excitation light, first and second λ/4 wavelength plates 223 and 224, a mirror 225, a dichroic mirror 226, and a mirror 227.

The solution supply system includes a reagent storing unit 211, a dispensing unit 212 and the inlet tube 213. The liquid waste collection system includes the outlet tube 214 and a liquid waste container 215. A temperature control unit, not shown, may be provided above the microchannel chip. In the case of providing the temperature control unit, sample liquid, regent, washing liquid and the like that are introduced into the reaction chamber can be kept at a prescribed temperature.

In this embodiment, when a solution from the inlet tube 213 is introduced into the reaction chamber 114 of the microchannel chip and discharged into the outlet tube 214, the liquid does not leak. For instance, the reaction chamber sheet 104 and the reaction substrate 101 closely adheres to each other, which prevents the solution from leaking therebetween. Accordingly, the solution is not in contact with the substrate holder 103.

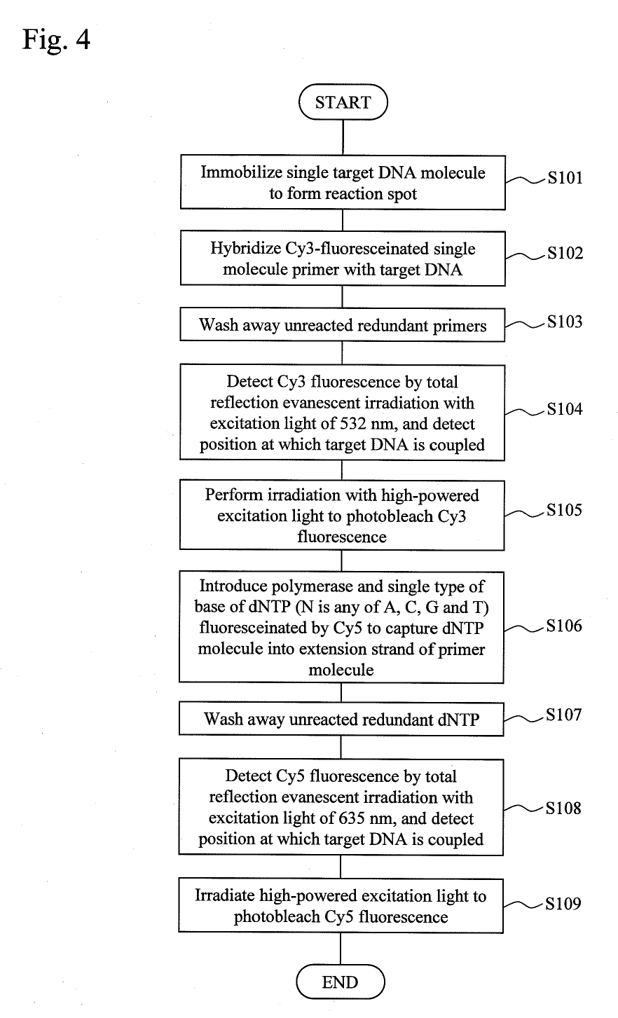

Referring to FIG. 4, a single molecule DNA sequence analysis method using the microchannel chip of the present invention will now be described. Here, the DNA sequencer shown in FIG. 3 is used. The reagent storing unit 211 stores a single target DNA molecule solution, a primer single molecule solution fluoresceinated by fluorochrome Cy3, a solution containing a single type of a base of dNTP (N is any of A, C, G and T) fluoresceinated by fluorochrome Cy5 and a polymerase, washing liquid and the like. The first laser unit 221 for excitation light emits laser light having a wavelength of 532 nm. The second laser unit 222 for excitation light emits laser light having a wavelength of 635 nm. The fluorochrome Cy3 emits light by laser light having the wavelength of 532 nm. The fluorochrome Cy5 emits light by laser light having the wavelength of 635 nm.

First, in step S101, the single target DNA molecule is immobilized onto the top surface of the reaction substrate to form the reaction spot. Biotin-avidin protein binding is utilized for immobilizing the target DNA molecule. Unreacted redundant target DNA molecules are washed away. Thus, the desired reaction spot can be formed on the reaction substrate.

In step S102, the solution containing the primer fluoresceinated by the fluorochrome Cy3 is introduced into the channel formed in the microchannel chip. An intake port of the dispensing unit 212 is caused to communicate with the primer single molecule solution fluoresceinated by fluorochrome Cy3 that is stored in the reagent storing unit 211. The primer single molecule solution is introduced into the reaction chamber 114 of the microchannel chip through the inlet tube 213. The primer single molecule is hybridized to the target DNA molecule immobilized on the reaction spot. The hybridization reaction is performed for a prescribed time.

In step S103, unreacted redundant primers are washed away. An intake port of the dispensing unit 212 is caused to communicate with washing liquid in the reagent storing unit 211. The washing liquid is introduced into the reaction chamber 114 of the microchannel chip through the inlet tube 213. The unreacted redundant primers are washed away with washing liquid, and discharged from the reaction chamber 114 to the liquid waste container 215 through the discharge channel 113, the outlet 111 and the outlet tube 214.

In step S104, total reflection evanescent irradiation with excitation light of 532 nm detects fluorescence of Cy3. The detection of the fluorescence of Cy3 can, in turn, detect the position of the primer single molecule hybridized to the target DNA molecule immobilized on the reaction spot.

Laser light having the wavelength of 532 nm from the first laser unit 221 for excitation light is introduced into the total reflection prism 120 through the λ/4 wavelength plate 223, the mirror 225, the dichroic mirror 226 and the mirror 227. The laser light introduced into the total reflection prism 120 is totally reflected by the top surface of the reaction substrate. At this time, only the significantly limited region including the metal structure formed at the reaction spot 102 is illuminated with evanescent light. The evanescent light causes the fluorochrome Cy3 of the primer molecule to emit light. Furthermore, localized surface plasmons occur at the metal structure formed at the reaction spot 102, thereby allowing the fluorescence to be increased.

This fluorescence is detected by the two-dimensional sensor camera (detector) 234 through the objective lens 231, the fluorescent wavelength filter 232 and the imaging lens 233. A two-dimensional luminance signal acquired by the two-dimensional sensor camera (detector) 234 is transmitted to the device control computer 240 via the camera controller (detector controller) 235, and further transmitted to the analysis computer 241.

In step S105, Cy3 is fluorescence-photobleached by irradiating high-powered excitation light, thereby suppressing fluorescence emission thereafter. That is, the laser light output from the first laser unit 221 for excitation light is increased to thereby photobleaching the fluorochrome Cy3.

In step S106, the solution containing the single type of a base of dNTP (N is any of A, C, G and T) fluoresceinated by fluorochrome Cy5 and polymerase is introduced into the channel formed in the microchannel chip. The intake port of the dispensing unit 212 is caused to communicate with the solution containing the single type of a base of dNTP (N is any of A, C, G and T) fluoresceinated by fluorochrome Cy5 and polymerase that is stored in reagent storing unit 211. This solution is introduced into the reaction chamber 114 of the microchannel chip through the inlet tube 213. The dNTP (N is any of A, C, G and T) complement to the target DNA molecule is captured into the extension strand of the primer molecule at the reaction spot. Base extension reaction is performed for a prescribed time.

In step S107, unreacted redundant dNTPs are washed away. The intake port of the dispensing unit 212 is caused to communicate with the washing liquid in the reagent storing unit 211. This washing liquid is introduced into the reaction chamber 114 of the microchannel chip through the inlet tube 213. The unreacted redundant dNTPs are washed away with the washing liquid, and discharged from the reaction chamber 114 into the liquid waste container 215 through the discharge channel 113, the outlet 111 and the outlet tube 214.

In step S108, Cy5 fluorescence is detected by total reflection evanescent irradiation with excitation light of 635 nm. The detection of the Cy5 fluorescence can, in turn, detect the position at which dNTP is captured into the extension strand of the primer molecule. That is, the position of the target DNA molecule complement to the dNTP molecule can be detected.

Laser light having the wavelength of 635 nm from the second laser unit 222 for excitation light is introduced into the total reflection prism 120 through the λ/4 wavelength plate 224, the dichroic mirror 226 and the mirror 227. The laser light introduced into the total reflection prism 120 is totally reflected by the top surface of the reaction substrate. At this time, only the significantly limited region including the metal structure formed at the reaction spot 102 is illuminated with evanescent light. The evanescent light causes the fluorochrome Cy5 of the dNTP molecule to emit light. Furthermore, localized surface plasmons occur at the metal structure formed at the reaction spot 102, thereby allowing the fluorescence to be increased.

This fluorescence is detected by the two-dimensional sensor camera (detector) 234 through the objective lens 231, the fluorescent wavelength filter 232 and the imaging lens 233. A two-dimensional luminance signal acquired by the two-dimensional sensor camera (detector) 234 is transmitted to the device control computer 240 via the camera controller (detector controller) 235, and further transmitted to the analysis computer 241.

In step S109, Cy5 is fluorescence-photobleached by irradiating high-powered excitation light, thereby suppressing fluorescence emission thereafter. That is, the laser light output from the second laser unit 222 for excitation light is increased to thereby photobleaching the fluorochrome Cy5.

Next, the type of a base in the dNTP (N is any of A, C, G and T) is sequentially changed in a manner, for instance, A>C>G>T>A, and steps S102 to S109 are repeated (stepwise elongation reaction). The analysis computer 241 identifies the base sequence complement to the target DNA molecule on the basis of the position of the primer molecule coupled with the target DNA and the position of the dNTP molecule.

### Embodiment 2

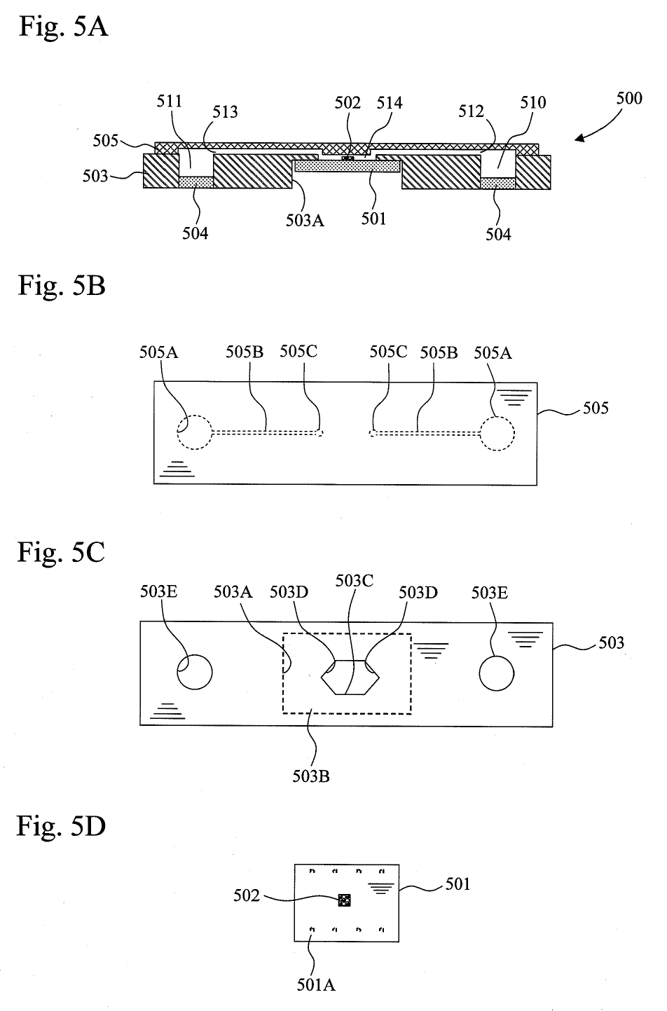

Referring to FIGS. 5A, 5B, 5C and 5D, an example of the microarray chip of the present invention will now be described. The microarray chip of this embodiment is configured for a microarray chip for genetic analysis. More specifically, a diagnostic device is assumed that uses hybridization by electrochemical coupling in a microelectrode pad array. The microarray chip of this embodiment is assumed to be disposable.

As shown in FIG. 5A, the microarray chip 500 of this embodiment includes a substrate holder 503, a reaction substrate 501 mounted on the substrate holder 503, and a channel sheet 505 disposed so as to cover the substrate holder 503 and the reaction substrate 501. Between two main surfaces of each of the reaction substrate 501, the substrate holder 503 and the channel sheet 505, the upper surface in FIGS. 5A, 5B, 5C and 5D is referred to as a top surface, and the lower surface is referred to as an undersurface.

A reaction spot 502 is formed on the top surface of the reaction substrate 501. In the microarray chip for genetic analysis of this embodiment, in a sectional view of FIG. 5A, the reaction spot 502 is irradiated with illumination light from the top through the channel sheet 505. The reaction spot 502 is observed through the channel sheet 505 from the top. Accordingly, the channel sheet 505 is formed of a transparent material.

The microarray chip includes an inlet chamber 510, a supply channel 512, a reaction chamber 514, a discharge channel 513 and an outlet chamber 511. The inlet chamber 510 and the outlet chamber 511 are blocked with respective septa 504. The septa 504 are thin films formed of a material, such as rubber or silicone.

The inlet chamber 510, the supply channel 512, the reaction chamber 514, the discharge channel 513 and the outlet chamber 511 sequentially communicate with each other to internally form a closed channel. In the microarray chip, the internal space is completely closed, thereby preventing a solution stored therein from leaking. Accordingly, the desired reaction spot 502 is preliminarily formed in the reaction substrate 501, and microarray chip internally filled with the solution can be conveyed as it is.

FIG. 5D shows an example of the reaction substrate 501. The reaction spot 502 for analyzing genetic sequences, genetic polymorphism and the like is formed on the top surface of the reaction substrate 501.

The substrate holder 503 of this embodiment does not adopt the total reflection evanescent illumination detection method, but may use an effect of locally increasing fluorescence of localized surface plasmons. Accordingly, as with the example shown in FIG. 1E, it is preferred that the reaction spot 502 have a microstructure to facilitate occurrence of localized surface plasmons.

The reaction substrate 501 of this embodiment is different from the reaction substrate 101 shown in FIG. 1E in that the undersurface of the reaction substrate of this embodiment is provided with a plurality of control electrodes 501A. The reaction substrate of this embodiment 501 may be equivalent to the reaction substrate 101 shown in FIG. 1E except that the substrate is provided with the control electrodes 501A. Voltage is applied to microelectrodes formed at the reaction spot 502 through the control electrodes 501A. Thus, electrochemical coupling is achieved at the microelectrodes formed at the reaction spot 502.

As shown in FIG. 5C, a recess 503A for storing the reaction substrate 501 is formed on the undersurface of the substrate holder 503. A through-hole 503C is formed on the bottom surface of the recess 503A. Elements around the through-hole 503C form a reaction substrate holding section 503B for holding the reaction substrate.

The through-hole 503C forms the reaction chamber 514 of the microarray chip. More specifically, the shape of the reaction chamber 514 is identical to the shape of the through-hole 503C. In this embodiment, the shape of the through-hole 503C is a shape acquired by extending a hexagon in the longitudinal direction of the channel sheet. The corners at opposite ends 503D of the through-hole 503C are disposed along the central axis of the substrate holder 503. It is preferred that the through-hole 503C have a pointed shape at the opposite ends 503D on the central axis. This can prevent liquid flowing into the reaction chamber 514 from being left resident at the corners of the opposite ends. However, the shape of the through-hole 503C shown in the drawing is only an example. The shape may be a rhombus, an ellipse, a circle, a polygon, a rectangle or the like.

The dimensions of the through-hole 503C are larger than those of the reaction spot 502 but smaller than those of the reaction substrate 501. Accordingly, the bottom surface of the reaction chamber 514 is formed of the top surface of the reaction substrate 501 exposed at the through-hole 503C. A region that can be observed by a detection optical system at one time is hereinafter referred to as a “measurement visual field”. The bottom surface of the reaction chamber 514 has dimensions at least equivalent to or larger than those of the measurement visual field. Accordingly, the dimensions of the through-hole 503C are equivalent to or larger than the dimensions of the measurement visual field.

Furthermore, two through-holes 503E are formed in the substrate holder 503 along the central axis. The through-holes 503E have a circular shape, and are formed near the respective opposite ends of the substrate holder 503. The two through-holes 503E form the inlet chamber 510 and the outlet chamber 511 of the microarray chip.

The substrate holder 503 has dimensions equivalent to those of a typical slide glass. More specifically, the longitudinal and lateral dimensions are 26 mm×76 mm. The thickness is preferably about 2 mm, but may be 0.1 mm to 10 mm. The longitudinal and lateral dimensions of the recess 503A are larger than the longitudinal and lateral dimensions of the reaction substrate. The depth of the recess 503A is equivalent to or larger than the thickness of the reaction substrate 501. The thickness of the reaction substrate holding section 503B is preferably about 0.5 mm, but may be 0.01 mm to 5 mm. The longitudinal and lateral dimensions of the through-hole 503C are smaller than the longitudinal and lateral dimensions of the reaction substrate 501. Accordingly, the reaction substrate 501 can be mounted on the reaction substrate holding section 503B. The substrate holder 503 of this embodiment may be formed of a material equivalent to that of the substrate holder 103 shown in FIG. 1D.

As shown in FIG. 5B, the channel sheet 505 may have a shape and dimensions equivalent to those of the external shape of the substrate holder 503. However, in this embodiment, the dimensions of the channel sheet 505 in the longitudinal direction are slightly smaller than the dimensions of the substrate holder 503 in the longitudinal direction. Two recesses 505A are formed on the undersurface of the channel sheet 505 along the central axis. The recesses 505A have a circular shape, and are formed near the respective opposite ends of the channel sheet 505. Two grooves 505B are formed on the undersurface of the channel sheet 505. These grooves extend from the respective recesses 505A toward the center along the central axis of the substrate holder 503. Recesses 505C having a small circular shape are formed at the other ends of the respective grooves.

The groove 505B has a depth of about 50 μm, and the width of about 500 μm. The depths of the recesses 505A and 505C may be identical to the depth of the groove 505B. The diameter of the recess 505C may be identical to the width of the groove 505B. Instead, this diameter may be larger than the width of the groove.

The through-holes 503E of the substrate holder 503 and the recesses 505A of the channel sheet 505 form the inlet chamber 510 and the outlet chamber 511 of the microarray chip. The two grooves 505B of the channel sheet 505 form the supply channel 512 and the discharge channel 513 of the microarray chip.

The recesses 505A at the external ends of the two grooves 505B are disposed at positions corresponding to the two respective through-holes 503E of the substrate holder 503. The recesses 505C at the inner ends of the two grooves 505B are formed at positions that correspond to the respective opposite ends 503D of the through-hole 503C of the substrate holder 503 and inner than the through-hole 503C.

The channel sheet 505 of this embodiment may be formed of a material equivalent to that of the channel sheet 105 shown in FIG. 1B.

A method of assembly the microarray chip of this embodiment will now be described. The septa 504 are inserted into the respective through-holes 503E on the undersurface of the substrate holder 503. The septa 504 completely block the openings of the respective two through-holes 503E. Next, the reaction substrate 501 is caused to adhere to the reaction substrate holding section 503B of the recess 503A of the substrate holder 503. An adhesion method will be described. First, a hydrophilicity process is applied to the entire undersurface or an area like a picture frame in the undersurface of the reaction substrate 501, and then resin coating, such as of PDMS, is applied thereto. A superhydrophilic coating film, such as of SiO2 or TiO2, can be used for the hydrophilicity process. Next, the reaction substrate 501, to which the hydrophilicity process and the resin coating are thus applied, is attached in the recess 503A of the substrate holder 503. The self-adhesion of the PDMS coating on the reaction substrate 501 allows the reaction substrate 501 to adhere onto the reaction substrate holding section 503B in the recess of the substrate holder 503.

The adhesion area between the recess 503A of the substrate holder 503 and the reaction substrate 501 in this embodiment is larger than that of the example shown in FIG. 1A. Accordingly, the reaction substrate 501 and the substrate holder 503 securely adhere to each other on the adhesion surface therebetween. Liquid flowing into the reaction chamber 514 does not leak between the reaction substrate 501 and the substrate holder 503. In the adhesion method of this embodiment, it is preferred to use no adhesive. This is preferred for the sake of eliminating the possibility that the liquid flowing into the reaction chamber 514 is brought into contact with the adhesive.

The dimensions of the through-holes 503C of the substrate holder 503 are smaller than those of the reaction substrate 501. Accordingly, the reaction substrate 501 blocks the through-holes 503C. No gap is formed between the substrate holder 503 and the reaction substrate 501 around the through-holes 503C. The top surface of the reaction substrate 501 is exposed at the through-holes 503C. More specifically, the reaction spot 502 on the top surface of the reaction substrate 501 is exposed at the through-holes 503C. The undersurface of the reaction substrate 501 is exposed to the outside through the recess 503A of the substrate holder 503.

Next, the channel sheet 505 is attached to the top surface of the substrate holder 503. In this embodiment, the channel sheet 505 is formed of PDMS. Accordingly, the self-adhesion of PDMS allows the channel sheet 505 to adhere onto the top surface of the substrate holder 503. The microarray chip is thus formed. In the thus formed microarray chip, the reaction chamber 514 is formed where the channel sheet 505 is the ceiling surface, the reaction substrate 501 is the bottom surface, and the through-hole 503C of the substrate holder 503 is the side surface. Furthermore, the supply channel 512 and the discharge channel 513 are formed where the grooves 505B of the channel sheet 505 are the channels, and the top surface of the substrate holder 503 is the bottom surface.

The microarray chip of this embodiment includes the two elements, or the substrate holder 503 and the channel sheet 505. This chip thus has a smaller number of configurational elements than the first embodiment shown in FIG. 1A. In the first embodiment shown in FIG. 1A, the solution flowing into the channel in the microchannel chip is in contact with the reaction substrate 101, the reaction chamber sheet 104 and the channel sheet 105, but is not in contact with the substrate holder 103. In contrast, in the microarray chip of this embodiment, the solution flowing into the channel in the microarray chip is in contact with the reaction substrate 501, the channel sheet 505 and the substrate holder 503. That is, the solution, such as the reagent, is directly in contact with the adhesion area between the substrate holder 503 and the reaction substrate 501. Accordingly, it is preferred that no adhesive be used for the area where the substrate holder 503 and the reaction substrate 501 are in contact with each other.

An overview of an example of procedures for genetic analysis using the microarray chip for genetic analysis of this embodiment will now be described. First, oligonucleotides whose one end is biotinylated and whose base sequence is known (capture oligo) is supplied at the reaction spot on the reaction substrate. A voltage is applied to the microelectrodes at the reaction spot through the control electrodes. The oligonucleotides (capture oligo) are attracted to the microelectrodes, and brought into contact with a permeation layer structure on the surface of the reaction spot. The biotin label of the oligonucleotides (capture oligo) and the permeation layer structure cause an avidin-biotin reaction. Thus, the oligonucleotides (capture oligo) are immobilized to the permeation layer structure. The washing liquid is supplied into the reaction chamber in the microarray chip, thereby washing away unreacted and redundant oligonucleotides (capture oligo).

Next, the aforementioned processes are repeated using another oligonucleotides (capture oligo). This allows a desired oligonucleotide array made of oligonucleotides (capture oligo) to be formed at the reaction spot.

Next, a PCR product (sample oligos) as an analysis target in which a part of base sequence is unknown is supplied to the reaction chamber in the microarray chip. The PCR product (sample oligos) is hybridized to oligonucleotides (capture oligo) having the complementary sequence, at the reaction spot. This hybridization allows the PCR product (sample oligos) to be captured by the oligonucleotides (capture oligo) and to be immobilized at the reaction spot. The reaction spot is washed with the washing liquid to wash away the unreacted and redundant PCR product (sample oligos).

Next, oligonucleotides (reporter oligos) whose one end is fluoresceinated are supplied to the reaction chamber in the microarray chip. These oligonucleotides (reporter oligos) are hybridized to the PCR product (sample oligos) having the complementary sequence, at the reaction spot. The reaction spot is washed with the washing liquid, thereby washing away unreacted and redundant oligonucleotides (reporter oligos).

The reaction spot on the reaction substrate of the microarray chip is irradiated with the excitation light. This excitation light allows the oligonucleotides (reporter oligos) hybridized with the PCR product (sample oligos) to emit fluorescence. The fluorescence pattern is detected and analyzed, thereby allowing the base sequence of the PCR product (sample oligos) to be analyzed.

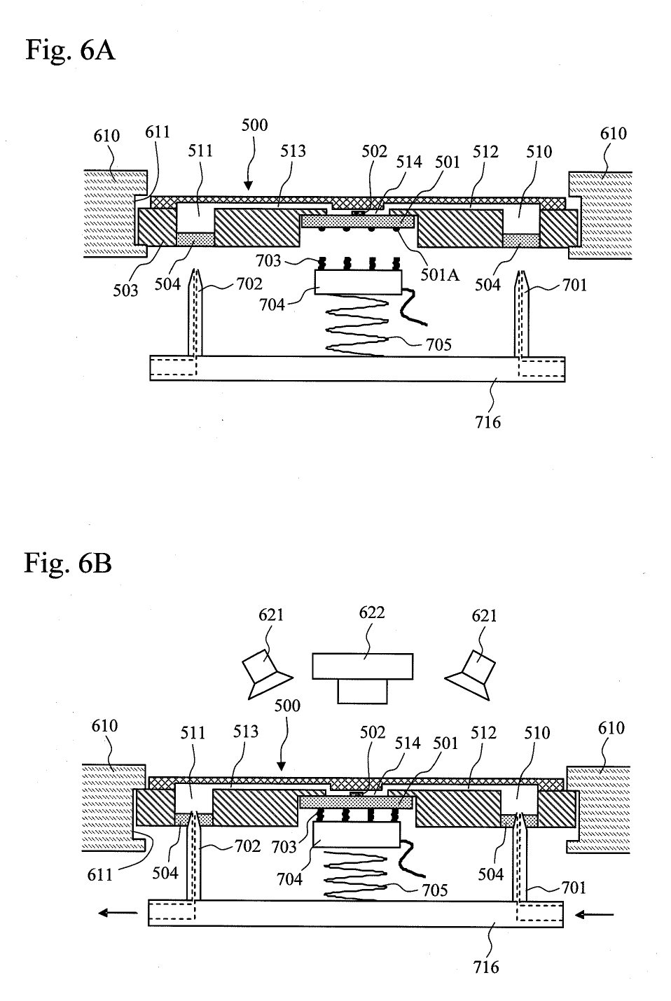

Referring to FIGS. 6A and 6B, a method of mounting the microarray chip for genetic analysis of this embodiment on the genetic analyzer will now be described. As shown in FIG. 6A, the microarray chip 500 of this embodiment is loaded onto supporting members 610. The opposite ends of the microarray chip 500 are engaged with respective recesses 611 of the supporting members 610. In this embodiment, the substrate holder 503 is exposed at the opposite ends of the microarray chip 500. Accordingly, the ends of the substrate holder 503 at the opposite ends of the microarray chip 500 are engaged with the respective recesses 611. The width of the recess 611 is larger than the thickness of the end of the substrate holder 503. The opposite ends of the substrate holder 503, that is, the opposite ends of the microarray chip 500, are disposed on the undersurfaces of the recesses 611 of the respective supporting members 610.

Oligonucleotides whose one end is biotinylated and whose base sequence is known (capture oligo) have already been coupled to the reaction substrate 501 of the microarray chip, in conformity with diagnostic purposes. For stable conservation of oligonucleotides, the inlet chamber 510, the supply channel 512, the reaction chamber 514, the discharge channel 513 and the outlet chamber 511 of the microarray chip are filled with a buffer, such as physiological saline solution.

An inlet needle 701 and an outlet needle 702 are disposed below the microarray chip 500. The inlet needle 701 and the outlet needle 702 are supported by the supporting member 716. Furthermore, electrodes 703 are provided below the microarray chip 500. The electrodes 703 are mounted on a supporting member 704. The supporting member 704 is supported by the supporting member 716 via a spring 705.

The inlet needle 701 and the outlet needle 702 are disposed below the respective septa 504. The electrodes 703 are disposed below the reaction substrate 501.

As shown in FIG. 6B, the supporting member 716 is upwardly moved. The inlet needle 701, the outlet needle 702 and the electrodes 703 are elevated. The inlet needle 701 and the outlet needle 702 pierce the respective septa 504. When the supporting member 716 is moved further upwardly, the electrodes 703 are engaged with the control electrodes 501A (see FIG. 5D) on the undersurface of the reaction substrate 501, thereby forming an electric circuit.

When the supporting member 716 is moved further upwardly, the distal ends of the inlet needle 701 and the outlet needle 702 are disposed in the inlet chamber 510 and the outlet chamber 511 of the microarray chip, respectively. The septa 504 are formed of an elastically deformable film, such as of rubber. Accordingly, even though the inlet needle 701 and the outlet needle 702 pierce the septa 504, areas between the inlet needle 701 and the outlet needle 702 and the septa 504 are sealed. That is, the sealing performances of the inlet chamber 510 and the outlet chamber 511 are secured. Liquid in the inlet chamber 510 and the outlet chamber 511 does not leak between the inlet needle 701 and the outlet needle 702 and the septa 504.

When the supporting member 716 is moved further upwardly, the microarray chip 500 is elevated, and the opposite ends of the substrate holder 503, that is, the opposite ends of the microarray chip 500, are brought into contact with the top surface of the recesses 611 of the supporting members 610. When the supporting member 716 is moved further upwardly, the spring 705 is compressed. The compression power of the spring 705 presses the electrodes 703 against the control electrodes 501A (see FIG. 5D) on the undersurface of the reaction substrate 501.

The top surfaces of the recesses 611 of the supporting members 610 define a reference position of the microarray chip 500. More specifically, it can be defined that, when the opposite ends of the microarray chip 500 are in contact with the top surfaces of the recesses 611 of the supporting member 610, the microarray chip 500 is disposed at the reference position. The definition of the reference position of the microarray chip 500 facilitates to maintain the relative positional relationships between an optical observation system, the substrate holder 503 and the reaction substrate 501 to prescribed values.

After the attachment operation is thus completed, an experiment for genetic analysis is performed. For instance, a reagent in which an expressed gene of a subject cell or the like is labeled with a fluorochrome or the like is hybridized on the reaction spot 502 of the reaction substrate 501 to couple complement nucleic acids (DNA or RNA) with each other, thereby labeling the spot with the fluorochrome or the like. The reaction spot 502 is illuminated by the illumination device 621. Observation is made using a CCD camera 622. The camera 622 has preliminarily been mounted with an optical band-pass filter that only passes fluorescence wavelengths, thereby discriminating only fluorescent signals for allowing observation.

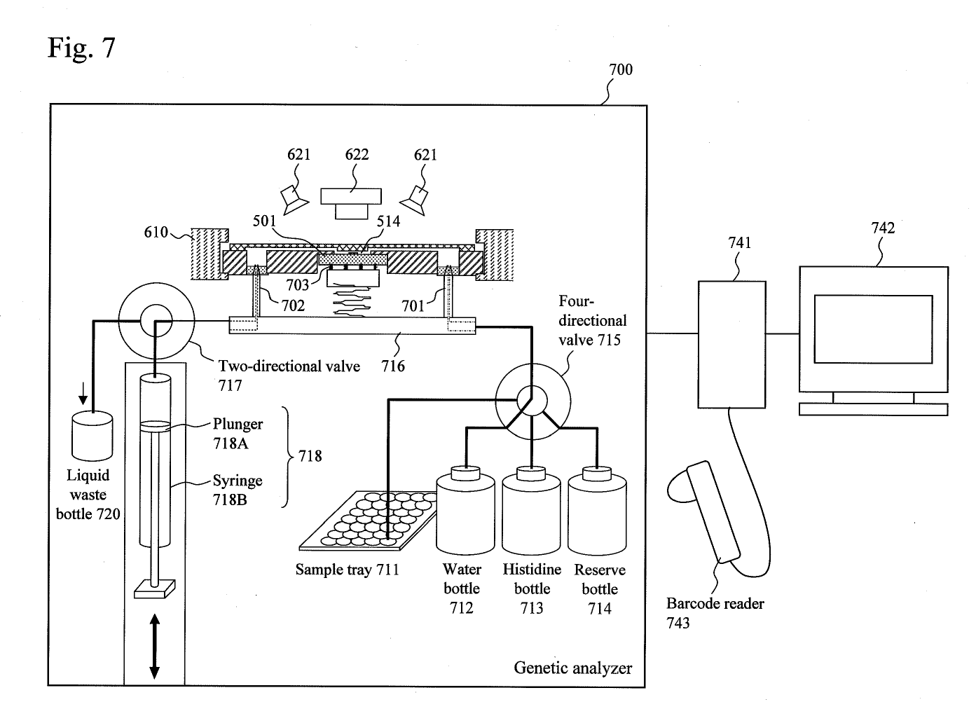

Referring to FIG. 7, an example of the configuration of the genetic analysis system will now be described. The genetic analysis system of this embodiment includes a genetic analyzer 700, an analysis computer 741, an output device 742 and a barcode reader 743. The analyzer 200 includes a detection optical system provided above the microarray chip 500, a solution supply system provided at the right below the microarray chip 500, and a liquid waste collection system disposed at the left below the microarray chip 500.

The detection optical system includes the illumination device 621, and the CCD camera 622. The camera 622 is mounted with the optical band-pass filter that only passes prescribed fluorescence wavelengths.

The solution supply system includes a sample tray 711, a washing water bottle 712, a histidine bottle 713, a reserve bottle 714 and a four-directional valve 715. A plurality of samples or reagents can be stored on the sample tray 711. The sample tray 711 can be moved in X-Y-Z directions by a stage device, not shown. Histidine, which is used as a reaction solution, is stored in the histidine bottle 713.

The sample tray 711, the washing water bottle 712, the histidine bottle 713 and the reserve bottle 714 are interchangeable. The four-directional valve 715 causes any of the sample tray 711, the washing water bottle 712, the histidine bottle 713 and the reserve bottle 714 to communicate with the reaction chamber 514 in the microarray chip.

The liquid waste collection system includes a two-directional valve 717, a suction device 718 and a liquid waste bottle 720. The two-directional valve 717 causes any of the reaction chamber 514 in the microarray chip and the liquid waste bottle 720 to communicate with the suction device 718. The suction device 718 includes a plunger 718A and a syringe 718B.

An operation of the genetic analysis system of this embodiment will now be described. First, the four-directional valve 715 causes a prescribed sample storage on the sample tray 711 to communicate with the reaction chamber 514 in the microarray chip. The two-directional valve 717 causes the reaction chamber 514 in the microarray chip to communicate with the suction device 718. The plunger 718A is downwardly driven, thereby allowing the solution filled in the reaction chamber 514 in the microarray chip and the channel to be sucked by the syringe 718B. Instead, the reaction chamber 514 in the microarray chip and the channel are filled with the sample solution stored in the sample tray 711. This operation is referred to as filling.

Next, the two-directional valve 717 causes the liquid waste bottle 720 and the suction device 718 to communicate with each other. The plunger 718A is upwardly driven, thereby allowing the solution filled in the syringe 718B to be discharged into the liquid waste bottle 720. This operation is referred to as flushing.

Next, the four-directional valve 715 causes the washing water bottle 712 and the reaction chamber 514 in the microarray chip to communicate with each other. The two-directional valve 717 causes the reaction chamber 514 in the microarray chip to communicate with the suction device 718. The plunger 718A is downwardly driven, thereby allowing a liquid waste filled in the reaction chamber 514 in the microarray chip to be sucked by the syringe 718B. Instead, the reaction chamber 514 in the microarray chip and the channel are filled with the washing liquid stored in the washing water bottle 712. That is, filling of the washing liquid is performed.

Next, the two-directional valve 717 causes the liquid waste bottle 720 and the suction device 718 to communicate with each other. The plunger 718A is upwardly driven, thereby allowing the liquid waste filled in the syringe 718B to be discharged into the liquid waste bottle 720. That is, flushing of the liquid waste is performed. Thus, the filling and the flushing are repeated, thereby allowing a desired solution to be supplied and discharged.

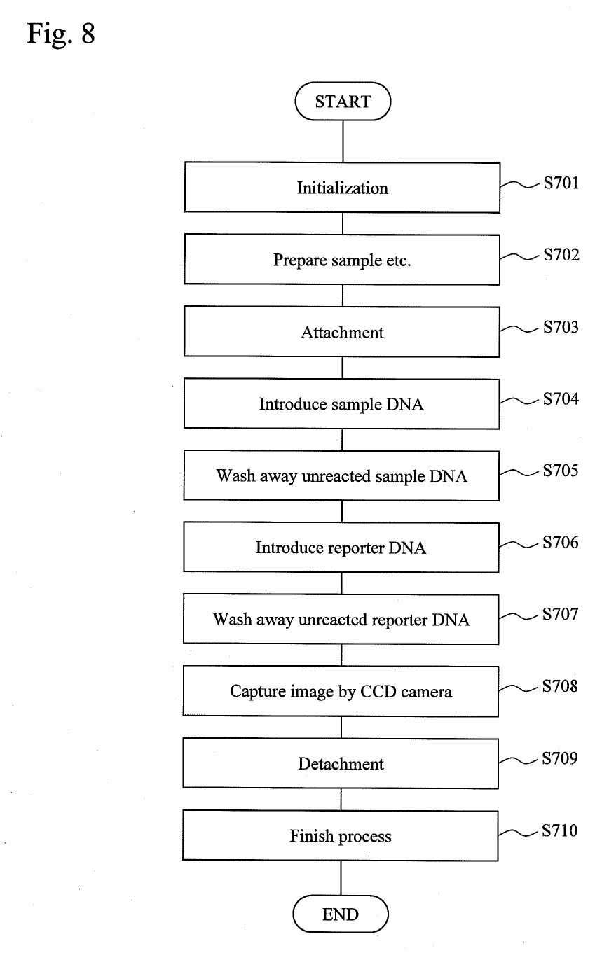

Referring to FIG. 8, an operation of the genetic analysis system will now be described. In step S701, a power source of the genetic analysis system is turned on, and initialization is performed. In the initialization, the volume of the washing liquid in the washing water bottle 712 is verified, and the volume of the histidine in the histidine bottle 713 is verified. In step S702, a sample and the like are prepared. In this embodiment, oligonucleotides whose one end is biotinylated and whose base sequence is known (capture oligo) have preliminarily been immobilized at the reaction spot of the reaction substrate of the microarray chip 500 for genetic analysis, in conformity with diagnostic purposes. The microarray chip 500 for genetic analysis may be prepared at another place. Sample DNAs (sample oligos), reporter DNAs (reporter oligos) and the like are stored on the sample tray 711. For instance, the barcode reader 743 reads a barcode provided on the sample tray 711, the bottles 712 and 713, the microarray chip 500 for genetic analysis or substrate holder 503. The read identification symbol and the like are transmitted to the analysis computer 741. The analysis computer 741 causes the output device 742 to display an instruction screen, thereby issuing a prescribed instruction to a user.

In step S703, attachment is performed. As shown in FIG. 6A, the microarray chip 500 is mounted on the supporting member 610. The inlet needle 701, the outlet needle 702 and the electrodes 703 are elevated. As shown in FIG. 6B, the inlet needle 701 and the outlet needle 702 pierce the septa 504. Further upward movement of the supporting member 716 allows the electrodes 703 to engaged with the respective control electrodes 501A (see FIG. 5D) on the undersurface of the reaction substrate 501

In step S704, the sample DNA is introduced into the reaction chamber 514 in the microarray chip. First, a sample tray X-Y-Z drive mechanism (not shown) disposes the sample tray 711 at a desired position. The four-directional valve 715 causes a prescribed sample DNA solution on the sample tray 711 to communicate with the reaction chamber 514 in the microarray chip. Next, the two-directional valve 717 causes the reaction chamber 514 in the microarray chip to communicate with the suction device 718. Filling is performed to suck into the syringe 718B the solution filled in the reaction chamber 514 in the microarray chip and the channel and, instead, to fill the reaction chamber 514 in the microarray chip and the channel with the sample DNA solution stored on the sample tray 711.

A current of about 0.2 mA is applied to a target position on the reaction spot 502 on the reaction substrate 501 for 60 seconds. The application of the current causes electric coupling at the target position, thereby capturing the sample DNA. That is, only a DNA having a sequence complementary to oligonucleotides (capture oligo) immobilized to the reaction spot is nonspecifically hybridized.

After the hybridization reaction is completed, unreacted sample DNAs are washed away in step S705. That is, flushing is performed to discharge the liquid in the reaction chamber 514 in the microarray chip into the liquid waste bottle. The filling and flushing of the washing water allows the reaction chamber 514 in the microarray chip and the channel to be washed.

In step S706, the fluoresceinated reporter DNA is introduced into the reaction chamber 514 in the reaction substrate of the microarray chip. First, the sample tray X-Y-Z drive mechanism (not shown) disposes the sample tray 711 at a desired position. The four-directional valve 715 causes a prescribed reporter DNA solution on the sample tray 711 to communicate with the reaction chamber 514 in the microarray chip. Next, the two-directional valve 717 causes the reaction chamber 514 in the microarray chip to communicate with the suction device 718. Filling is performed to suck the washing liquid filled in the reaction chamber 514 in the microarray chip and the channel into the syringe 718B and, instead, to fill the reaction chamber 514 in the microarray chip and the channel with the reporter DNA solution stored on the sample tray 711. This state is held for about 60 seconds. Accordingly, the captured sample DNA and reporter DNA are hybridized to each other.

After the hybridization reaction is completed, unreacted reporter DNAs are washed away in step S707. That is, flushing is performed to discharge the liquid in the reaction chamber 514 in the microarray chip into the liquid waste bottle. Filling and flushing of the washing water allows the reaction chamber 514 in the microarray chip and the channel to be washed. After the washing is completed, filling of the washing water allows the reaction chamber 514 in the microarray chip and the channel to be filled with the washing water.

In step S708, the CCD camera captures an image. First, the illumination device 621 irradiates the reaction spot on the reaction substrate with excitation light, and the camera 622 captures an image of fluorescence emitted by the fluorochrome. On the basis of the position of the fluorescence, the position of the reporter DNA (reporter oligos) can be verified. According to aforementioned steps, the oligonucleotides (capture oligo) preliminarily immobilized to the reaction spot on the reaction substrate of the microarray chip are coupled with the sample DNA (sample oligos). The fluoresceinated reporter DNA (reporter oligos) is further coupled with the sample DNA (sample oligos). Detection of the position of the reporter DNA (reporter oligos) allows the position of the sample DNA (sample oligos) to be detected.

In step S709, detachment is performed. After the image is captured, flushing is performed to discard the washing water held in the reaction chamber 514 in the microarray chip and the channel. Furthermore, the filling and flushing of the washing liquid are repeated, thereby washing the reaction chamber in the microarray chip, the reaction substrate and the channel. After the washing is completed, the inlet needle 701, the outlet needle 702 and the electrode 703 are lowered. This allows the channel coupling and the electric coupling to be canceled. The microarray chip 500 is removed from the supporting member 610.

In step S710, a finish process is performed. The configurational elements are returned to initial positions, and a state of allowing the power to be turned off is established.

### Embodiment 3

The present invention will now be described according to still another embodiment.

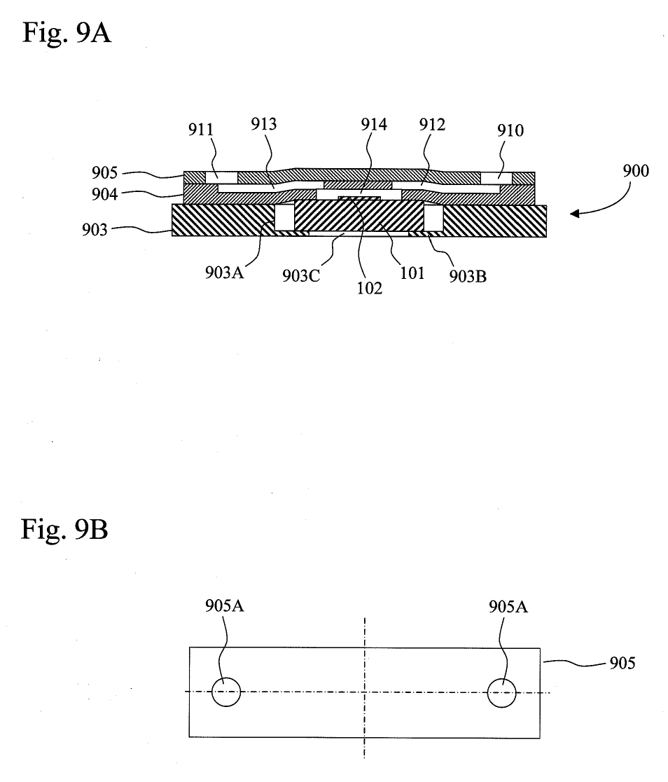

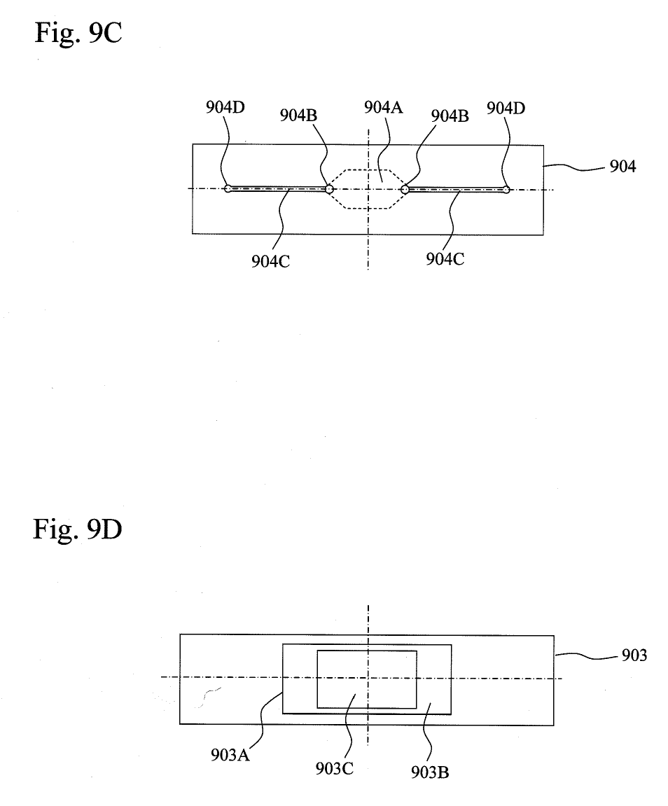

Referring to FIGS. 9A, 9B, 9C and 9D, an example of a microchannel chip 900 of the present invention will be described. A reaction substrate 101 equivalent to that of Embodiment 1 (FIG. 1E) is used. As shown in FIG. 9A, the microchannel chip of this embodiment includes a substrate holder 903, the reaction substrate 101 mounted on the substrate holder 903, a sheet 904 disposed on the substrate holder 903 and the reaction substrate 101, and a sheet 905 disposed thereon. Between two main surfaces of each of the substrate holder 903, the sheet 904 and the sheet 905 in FIGS. 9A, 9B, 9C and 9D, the upper surface is referred to as a top surface, and the lower surface is referred to as an undersurface.

As with Embodiment 1, the reaction spot 102 is formed on the top surface of the reaction substrate 101. The reaction substrate 101 is supported by the substrate holder 903. An illumination window 903C is formed on the undersurface of the microchannel chip. The undersurface of the reaction substrate 101 is exposed through the illumination window 903C, at which a total reflection prism can optically be attached or disposed. Accordingly, laser light is introduced to the reaction substrate, and is totally reflected by the reaction spot 102, thereby forming an evanescent field to excite fluorescent substances and the like. Emitted fluorescence is observed, condensed and detected from above through the sheets 904 and 905. The sheets 905 and 904 and the reaction substrate 101 are formed of a transparent material.

The microchannel chip includes an inlet 910, a supply channel 912, a reaction chamber 914, a discharge channel 913 and an outlet 911. The supply channel 912, the reaction chamber 914 and the discharge channel 913 sequentially communicate with each other to form a sealed channel.

The inlet 910 and the outlet 911 are formed at positions apart from the objective lens of the microscope and the arrangement of the elements of the excitation light source optical system so as not to interfere therewith. The outer diameter of the objective lens is typically about 30 mm. Furthermore, the objective lens having a high NA is required to be in proximity to the surface of the substrate. Accordingly, elements other than the cover structure of the reaction chamber in the reaction substrate cannot be disposed in a space including a region immediately below the objective lens. In this case, the inlet 910 and the outlet 911 are required to be formed at positions at least about 15 mm apart from the reaction spot 102 to avoid interference with the objective lens.

In this embodiment, the inlet 910 and the outlet 911 are disposed 20 mm apart from the reaction spot 102. More accurately, the inlet 910 and the outlet 911 are preferably formed at positions apart more than the range of measuring visual field+the objective lens outer diameter, in consideration of movement of the objective lens in the measuring visual field. In this embodiment, the inlet 910 and the outlet 911 are formed on the respective opposite sides with respect to the reaction spot as the center. The interval is 40 mm. The objective lens is disposed therebetween, thereby enabling fluorescence to be detected. Accordingly, the objective lens having a high NA can be used, thereby allowing highly sensitive fluorescence detection. This is suitable for a DNA base sequence analyzer, and for a single molecule method DNA base sequence analyzer.

The reaction substrate 101 is an element made of a thin plate-like member made of a quartz glass that has been cut from a quartz wafer to have a square form with a thickness of about 0.725 mm and a dimension of a side of about 10 mm. A metal structure or the like at which a DNA or the like can be immobilized is formed on at least a part of the top surface of the reaction substrate by a semiconductor manufacturing process. A configuration where an amino group, a carboxyl group, biotin, avidin or the like is coupled can be adopted instead of the metal structure. The reaction substrate may have a shape other than a square, for instance, a rectangular, polygonal or circular shape. Any size can be supported without limitation to a square of 10 mm. However, it is preferred that the dimensions be small.

As shown in FIG. 9D, a recess 903A for accommodating and holding the reaction substrate 101 is formed on the top surface of the substrate holder 903. A reaction substrate holding section 903B and a through-hole of about 9 mm×9 mm are formed on the bottom surface of the recess 903A. This through-hole forms an illumination window 903C of the microchannel chip. The reaction substrate 101 is supported by the reaction substrate holding section 903B. The undersurface of the reaction substrate 101 is exposed through the illumination window 903C. It is sufficient that at least one of the longitudinal and lateral dimensions of the illumination window 903C be smaller than the longitudinal and lateral dimensions of the reaction substrate 101. For instance, the dimensions are 8 mm×10 mm, 10 mm×8 mm or the like. This allows the reaction substrate holding section 903B to support the reaction substrate 101. It is sufficient that the longitudinal and lateral dimensions of the recess 903A be close to as much as possible but larger than the longitudinal and lateral dimensions of the reaction substrate. The dimensions may be about 10.5 mm×14 mm. It is sufficient that the depth of the recess 903A be substantially identical to the thickness of the reaction substrate 101, and defined to be 0.7 mm. The thickness of the reaction substrate holding section 903B is not specifically limited. However, in the case of total reflection illumination, it is preferred that this section be as thin as possible, and the thickness is defined to be 0.1 mm. The thickness may be 0.05 to 0.3 mm.

The substrate holder 903 has dimensions equivalent to those of a typical slide glass. More specifically, the longitudinal and lateral dimensions of are 26 mm×76 mm. The thickness is 0.8 mm according to the above description.

The substrate holder 903 is made of a material resistant to unintentional handling errors and dropping by users. This material is any of metals, such as stainless steel, aluminum and iron, and resins, such as acrylic and polystyrene.

As shown in FIG. 9C, the sheet 904 has a shape and dimensions equivalent to or slightly smaller than those of the external shape of the substrate holder 903. The thickness is 100 μm. A recess 904A (opening at the undersurface side; with a depth of 50 μm) is formed at the center of the sheet 904. Close contact between the sheet 904 and the reaction substrate allows the region of the recess 904A to serve as the reaction chamber 914. The recess 904A has a size that is larger than the region of the reaction spot 102 and smaller than the entire reaction substrate 101. The center of the recess 904A matches with the reaction spot 102. The reaction chamber 914 is formed on and above the reaction spot 102. A region that can be observed by the detection optical system at one time is hereinafter referred to as a “measurement visual field”. The bottom surface of the reaction chamber 914 has dimensions at least equivalent to or larger than the dimensions of the measurement visual field. Through-holes 904B, which are at the opposite ends of the respective recess 904A, communicate with two grooves 904C formed on the top surface and further communicate with opposite ends 904D. The depths of the groove 904C and the opposite ends 904D are about 50 μm. The width of the groove 904C is about 500 μm. The opposite ends 904D have a diameter of 1 mm. The through-holes 904B have a diameter of 1 mm.

As shown in FIG. 9B, the sheet 905 has a shape and dimensions equivalent to those of the sheet 904, and a thickness of 100 μm. Two through-holes 905A are formed on the sheet 905 at positions identical to those of the respective opposite ends 904D of the sheet 904. The through-hole 905A has a circular shape and a diameter of 2 mm. The sheet 904 and the sheet 905 are brought into close contact and adhere to each other. This allows the grooves 904C on the top surface of the sheet 904 and the undersurface of the sheet 905 to form the channels 912 and 913, and allows the two through-holes 905A of the sheet 905 to serve as the inlet 910 and the outlet 911.

Accordingly, a channel communicating with the inlet 910, the channel 912, the reaction chamber 914, the channel 913 and the outlet 911 is formed. Although not shown in the drawing, as with FIG. 2, the inlet 910 and the outlet 911 are caused to communicate with the inlet tube and the outlet tube, respectively, and then used.

It is preferred that the thicknesses of the sheets 905 and 904 be thick, in order to reduce adverse effects of deformation due to a pressure exerted on the channel. However, the thickness of the entire sheets 904 and 905 is required to be within a range that allows the objective lens to form an image. The maximum thickness is different according to the magnification and NA of the objective lens. Accordingly, the maximum thickness is brought into conformity with the objective lens. A material resistant to heat, cold, weather and chemicals is adopted. As such a material, a silicone resin, such as polydimethylsiloxane (PDMS), can be adopted. Since PDMS is adhesive, PDMS has an advantage capable of adhering to another element, such as glass, without use of an adhesive. Since PDMS is highly transparent, PDMS is effective for optical measurement. Another material other than PDMS may be adopted provided that the material can adhere and does not cause the reagents and experiment system for use to malfunction.

The sheet 905 has not been subjected to processes other than for the through-holes. Accordingly, this sheet may be a thin glass plate. This sheet can adhere to the sheet 904 as it is, and resistant to a pressure exerted on the channel, thereby enabling the strength to be improved.

The channels 912 and 913 are formed of the grooves 904C on the sheet 904 and the undersurface of the sheet 905. Instead, grooves equivalent to the grooves 904C may be formed on the undersurface of the sheet 905 to configure the channel.

In this embodiment, the shape of the recess 904A is the hexagon. However, this shape is only an example. Accordingly, this shape may be a rhombus, an ellipse, a circle, a polygon, a rectangle or the like. It is preferred that a taper or the like be formed for facilitating liquid, such as reagents, to flow.

Although not shown in this drawing, a measurement system adopting this microchannel chip can use the total reflection evanescent illumination detection method for the excitation light source optical system as with FIG. 2 or 3. The total reflection prism is optically coupled to the undersurface of the reaction substrate 101 by means of oil coupling. A total reflection prism smaller than the illumination window may be adopted, and may be coupled directly to an exposed part of the reaction substrate through the illumination window. Instead, a total reflection prism larger than the illumination window may be adopted, and brought into contact with the reaction substrate holding section 903B to be coupled by filling oil or the like in a space of thickness of the reaction substrate holding section.

Laser light for excitation is incident on the total reflection prism, passes through the oil coupling, and is introduced into the reaction substrate, thereby allowing the reaction spot on the top surface to be irradiated with this light. The reaction chamber on and above the reaction substrate and the reaction spot is filled with aqueous solutions, such as the reaction reagent solution and washing liquid. The refractive index of the quartz glass of the reaction substrate is about 1.46. The refractive index of water is about 1.33. The incident angle from the reaction substrate to the reaction chamber becomes critical at about 66 degrees. Light incident at an angle exceeding the critical angle is totally reflected by the interface. Accordingly, it is adjusted such that the incident angle at the interface is about 68 degrees. Light is totally reflected at the reaction spot to form an evanescent field in a space of the reaction chamber that is immediately on and above the reaction spot, thereby exciting fluorescent substances in this region. Emitted fluorescence is observed, condensed and detected from above by the objective lens, as described above.

Instead of the total reflection prism, the objective lens may be used for evanescent illumination. A quartz glass plate having a thickness of 0.17 mm is adopted as the reaction substrate. An objective lens of an NA of 1.4 or more is disposed on the undersurface of the reaction substrate, and optically coupled to the undersurface of the reaction substrate 101 by means of oil coupling. Adjustment of the optical path of the laser light to be incident on the objective lens introduces the laser light to the reaction substrate and allows the light to be totally reflected by the interface with the aqueous solution on the top surface. The emitted fluorescence can be condensed using the identical objective lens and detected.

In this embodiment, with respect to the reaction substrate 101 that is the square having a side of about 10 mm, the interval between the inlet and the outlet for introducing and discharging a reagent has a width of 40 mm. Thus, the interval can be defined to have a size exceeding that of the substrate. This configuration is realized by adopting the two-layer configuration of the sheets 904 and 905 and providing the channel therebetween. This configuration can be adopted because, although the reaction chamber 914 on and above the reaction spot is required to be in contact with the surface of the substrate, the supply channel 912 for introducing a reagent into the chamber and the discharge channel 913 are not required to be in contact with the surface of the substrate. The inlet and the outlet also have a configuration without contact with the reaction substrate. Accordingly, the size of the reaction substrate can be minimized while widening the interval between the inlet and the outlet.

This embodiment can fabricate the chip at low cost. A substrate cut from a quartz wafer is adopted as the reaction substrate 101. Since a quartz wafer is expensive, it is required to cut many substrates in order to reduce the cost. In the embodiment, the size of the reaction substrate is that with a side of 10 mm. Accordingly, simple calculation shows that about 290 substrates can be acquired from a wafer having a diameter of 8 inches. As with the embodiment, in the case where the interval between the inlet and the outlet of the microchannel chip is 40 mm and, as a conventional art, these are fabricated on the upper side of the reaction substrate, it is required that the size of the substrate is about 45 mm broad and 10 mm long. In this case, only 58 substrates can be cut. In the case of a substrate having a length of the long side of 20 mm, 140 substrates can be cut. In the case of a length of the long side of 25 mm, 110 substrates can be cut. This allows the cost to be reduced. The structure of this embodiment can acquire many substrates, and fabricate chips at lower cost.

In this embodiment, the supply channel 912, which is for introducing a reagent into the reaction chamber 914, and the discharge channel 913 are not in contact with the surface of the reaction substrate. Accordingly, even if there is a gap between the reaction substrate and the substrate holder, liquid does not leak or exude and can stably and correctly flow. In this embodiment, the thickness of the reaction substrate is 0.725 mm, and the depth of the recess of the substrate holder is 0.7 mm. Accordingly, after the microchannel chip is assembled, a step appears between the top surface of the substrate and the top surface of the substrate holder. However, even with such a configuration, liquid does not leak or exude and can be transferred. In the case where the reaction substrate, the substrate holder, and the grooves formed thereon simply form the supply channel or the discharge channel, the reaction substrate is in contact with liquid. Accordingly, in the case with such a step, a problem of liquid leakage occurs. Furthermore, another problem occurs in that, since a gap necessarily appears between the reaction substrate and the substrate holder, liquid enter the gap and it is difficult to transfer the liquid into the reaction spot region. Even in the case of bridging the gap with an adhesive or the like, it is difficult to eliminate the gap. Accordingly, there is a high possibility of liquid leakage. Thus, this embodiment can minimize the size of the reaction substrate while widening the interval between the inlet and the outlet, and stably and correctly transfer liquid without leakage or exudation.

### Embodiment 4

The present invention will now be described according to still another embodiment.

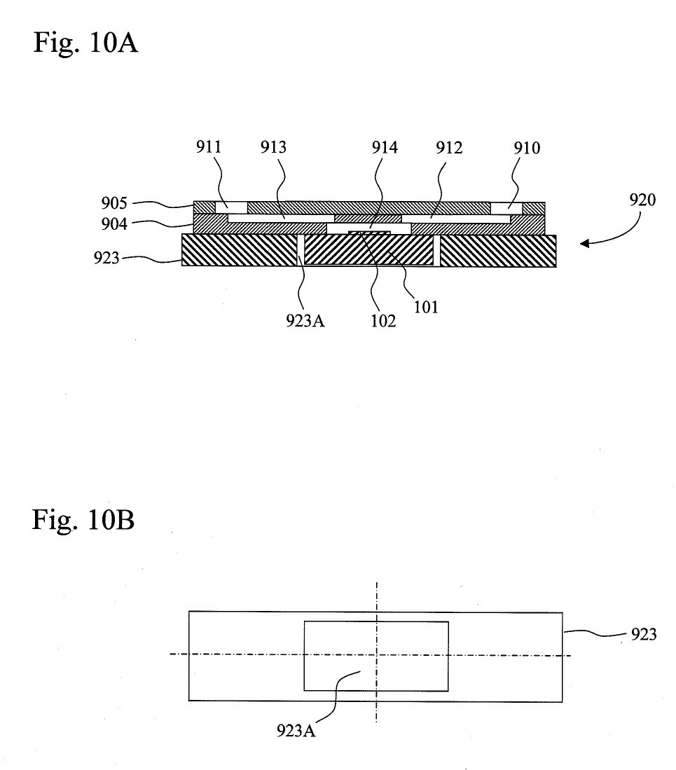

Referring to FIGS. 10A and 10B, an example of a microchannel chip 920 of the present invention will now be described. A reaction substrate 101 equivalent to that of Embodiment 1 (FIG. 1E) is adopted. The sheets 904 and 905 disposed to be in close contact with the upper side of the reaction substrate, which are identical to those in Embodiment 3, are adopted. As shown in FIG. 10A, the microchannel chip of this embodiment includes a substrate holder 923, the reaction substrate 101, the sheet 904 disposed on the reaction substrate, and the sheet 905 disposed thereon. Between the two main surfaces of each of the substrate holder 923 and the sheets 904 and 905, the upper surface in FIGS. 10A and 10B is referred to as a top surface, and the lower surface is referred to as an undersurface.

As with Embodiment 3, the reaction spot 102 is formed on the top surface of the reaction substrate 101. The reaction substrate 101 is disposed in the through-hole 923A provided in the substrate holder 923, and supported by the sheet 904 adhering to the substrate holder 923 and the reaction substrate 101. The sheet 905 is mounted on the top surface of the sheet 904. The undersurface of the reaction substrate 101 is exposed. A total reflection prism can be caused to optically adhere to or disposed at this exposed part. Accordingly, laser light is introduced to the reaction substrate, and totally reflected by the surface of the reaction spot 102 to form an evanescent field and excite fluorescent substances and the like. The sheets 905 and 904 are made of a transparent material. Fluorescence and the like emitted from the surface of the reaction substrate is observed, condensed and detected from above.

As with Embodiment 3, the microchannel chip includes the inlet 910, the supply channel 912, the reaction chamber 914, the discharge channel 913 and the outlet 911. The supply channel 912, the reaction chamber 914 and the discharge channel 913 are sequentially connected to form a sealed channel. Each of the inlet 910 and the outlet 911 are disposed 20 mm apart from the reaction spot 102. The inlet 910 and the outlet 911 are about 40 mm apart from each other. This configuration forms a channel that communicates from the inside of a region of the reaction substrate 101 (square having a thickness of about 0.725 mm and a dimension of a side of about 10 mm) to the outside without liquid leakage. Without limitation due to the size of the reaction substrate, the inlet and the outlet are provided at a sufficiently wide interval at the outside of the region. Accordingly, the objective lens that is for observing and condensing fluorescence and has a high NA can be disposed in proximity to the microchannel chip, thereby allowing highly sensitive fluorescence detection.

The substrate holder 923 has dimensions equivalent to those of a typical slide glass. The longitudinal and lateral dimensions are 26 mm×76 mm. The thickness, which may be equivalent to that of the reaction substrate, is defined to be 0.725 mm. As shown in FIG. 9D, the substrate holder 903 includes the through-hole 923A. The through-hole has dimensions of about 11 mm×11 mm, and is defined to have a size capable of accommodating the reaction substrate 101 therein.

The reaction substrate is suspended and supported by the sheet 904. This can eliminates a step between the top surfaces of the reaction substrate and the substrate holder, thereby allowing the surfaces to be flat. The sheets 904 and 905 are also flat. Accordingly, a glass plate having a high strength can be adopted as the sheet 905. The reaction substrate is supported not only by the sheet 904 but also by the total reflection prism disposed on the undersurface.

This embodiment has the same channel configuration, and can exert advantageous effects equivalent to those of Embodiment 3.

### Embodiment 5

The present invention will now be described according to still another embodiment.

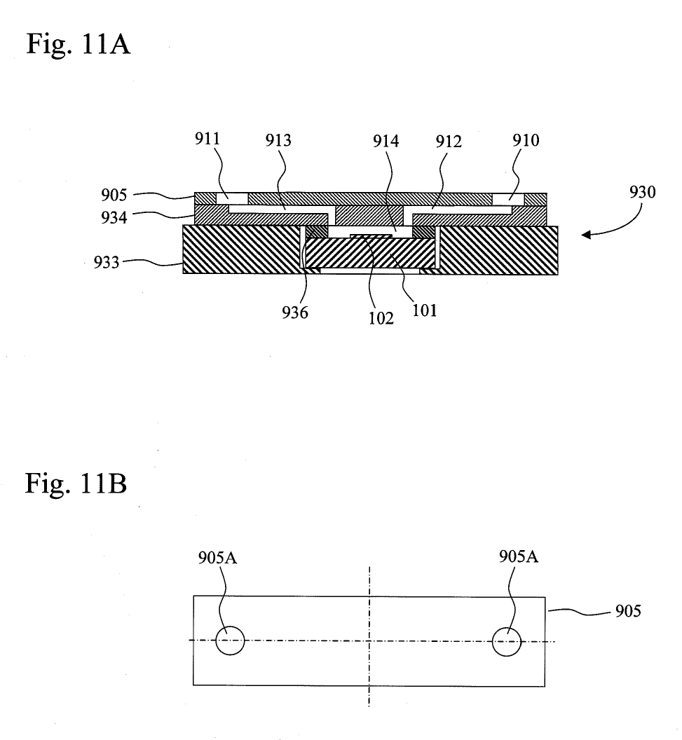

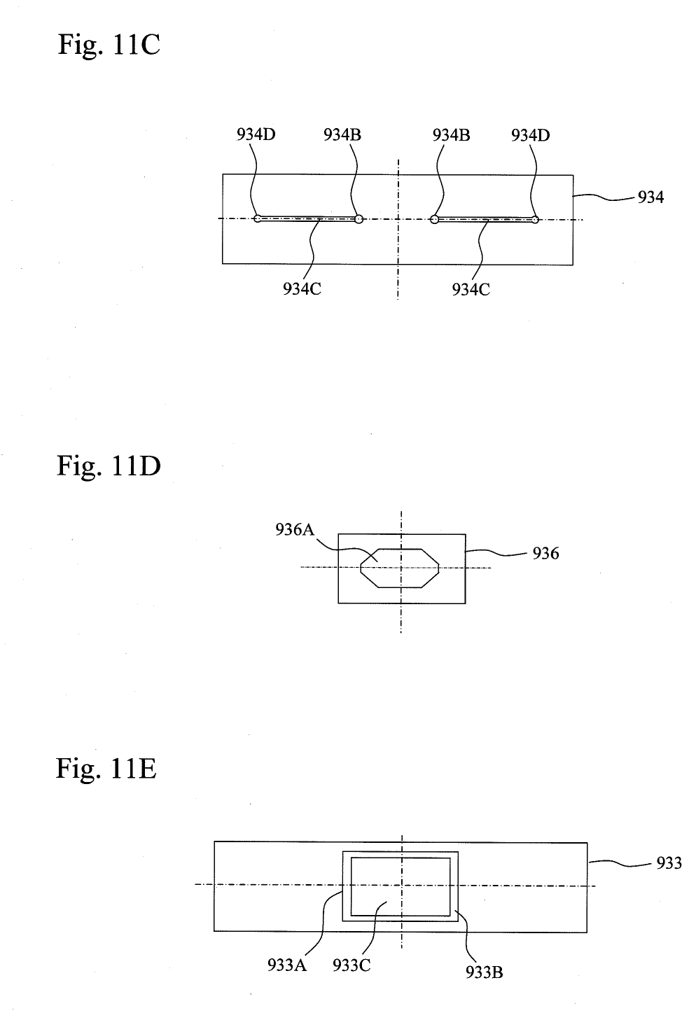

Referring to FIGS. 11A, 11B, 11C, 11D and 11E, an example of a microchannel chip 930 according to the present invention will now be described. A reaction substrate 101 equivalent to that of Embodiment 1 (FIG. 1E) is adopted. A sheet 905 that is disposed in close contact with the top of the reaction substrate and equivalent to that of Embodiment 3 is adopted. As shown in FIG. 11A, the microchannel chip of this embodiment includes a substrate holder 933, the reaction substrate 101, a sheet 934 disposed on the reaction substrate, the sheet 905 disposed thereon, and a sheet 936 between the reaction substrate 101 and the sheet 934. Between two main surfaces of each of the substrate holder 933, the sheets 936, 934 and 905, the upper surface in FIGS. 11A, 11B, 11C, 11D and 11E is referred to as a top surface, and the lower surface is referred to as an undersurface.

As with Embodiment 3, the reaction spot 102 is formed on the top surface of the reaction substrate 101 (square having a thickness about 0.725 mm and a dimension of a side of about 10 mm).

As shown in FIG. 11E, a recess 933A for accommodating and holding the reaction substrate 101 is formed on the top surface of the substrate holder 933. A reaction substrate holding section 933B and a through-hole having dimensions of about 9 mm×9 mm are formed on the bottom surface of the recess 933A. This through-hole forms an illumination window 933C of the microchannel chip. The reaction substrate 101 is supported by the reaction substrate holding section 933B. The undersurface of the reaction substrate 101 is exposed at the illumination window 933C. The longitudinal and lateral dimensions of the illumination window 933C may be smaller than the longitudinal and lateral dimensions of the reaction substrate 101, for instance, 9 mm×9 mm. This allows the reaction substrate holding section 933B to support the reaction substrate 101. The longitudinal and lateral dimensions of the recess 933A may be about 11 mm×11 mm. The depth of the recess 933A, which may be equivalent to the thickness of the reaction substrate 101, is defined to be 0.82 mm. The thickness of the reaction substrate holding section 933B is 0.1 mm. The longitudinal and lateral dimensions of the substrate holder 933 are 26 mm×76 mm. The thickness is 0.83 mm according to the above description.

The reaction substrate 101 is supported by the reaction substrate holding section 933B in the recess 933A. The undersurface of the reaction substrate 101 is exposed through the illumination window 933C. A total reflection prism can be caused to optically adhere to or disposed at this exposed part. Accordingly, laser light is introduced to the reaction substrate, and totally reflected by the surface of the reaction spot 102 to form an evanescent field and excite fluorescent substances and the like.

Emitted fluorescence is observed, condensed and detected from above through the sheets 934 and 905. The sheets 905 and 934 and the reaction substrate 101 are made of a transparent material.

A sheet 936 having a thickness of 0.095 mm is in close contact with the top surface of the reaction substrate 101. Accordingly, the difference in dimension of depth between the reaction substrate 101 and the recess 933A is bridged, thereby allowing the top surface of the substrate holder 933 and the top surface of the sheet 936 to be flat. The sheets 934 and 905 are disposed thereon to form a channel and the like. As shown in FIG. 11D, the sheet 934 includes a through-hole 936A having a size that is larger than the region of the reaction spot 102 and smaller than the entire reaction substrate 101, in an area that has a size substantially identical to that of reaction substrate 101 and corresponds to the reaction spot. Adhesion with the reaction substrate is made around the through-hole.

As shown in FIG. 11C, the sheet 934 has a shape and dimensions that are slightly smaller than the external shape of the substrate holder 933. The thickness is 100 μm. Close contact of the sheets 934 and 936 and the reaction substrate 101 in combination allows the region of the through-hole 936A to serve as the reaction chamber 914. The reaction chamber 914 is formed on and above the reaction spot 102. Through-holes 934B are formed at positions corresponding to the respective opposite ends of the through-hole 936A in the sheet 936 in the sheet 934. The through-holes 934B communicate with respective two grooves 934C formed on the top surface, and further communicate with opposite ends 934D. The depths of the grooves 934C and the opposite ends 934D are about 50 μm. The widths of the grooves 934C are about 500 μm. The opposite ends 934D have a diameter of 1 mm. The through-holes 934B have a diameter of 1 mm.

As shown in FIG. 11B, the sheet 905 has a shape and dimensions equivalent to those of the sheet 934. The thickness is 100 μm. In the sheet 905, two through-holes 905A are formed at positions identical to the respective opposite ends 934D of the sheet 934. The through-holes 905A have a circular shape and a diameter of 2 mm. The sheets 934 and 905 are brought into close contact with and adhere to each other. This allows the grooves 934C on the top surface of the sheet 934 and the undersurface of the sheet 905 to form the channels 912 and 913, while allowing the two through-holes 905A in the sheet 905 to serve as the inlet 910 and the outlet 911.

Accordingly, a channel communicating with the inlet 910, the channel 912, the reaction chamber 914, the channel 913 and the outlet 911 is formed.

A silicone resin, such as polydimethylsiloxane (PDMS), may be adopted as the material of sheets 934 and 936. Since PDMS is adhesive, PDMS has an advantage capable of adhering to another element, such as glass, without use of an adhesive. Since PDMS is highly transparent, PDMS is effective for optical measurement. Another material other than PDMS may be adopted provided that the material can adhere and does not cause the reagents and experiment system for use to malfunction. The sheet 936 may be made of an opaque material.

As with Embodiments 3 and 4, the microchannel chip includes the inlet 910, the supply channel 912, the reaction chamber 914, the discharge channel 913 and the outlet 911. The supply channel 912, the reaction chamber 914 and the discharge channel 913 sequentially communicate with each other to form a sealed channel. This configuration forms a channel that communicates from the inside of a region of the reaction substrate 101 (square having a thickness of about 0.725 mm and a dimension of a side of about 10 mm) to the outside without liquid leakage. Without limitation due to the size of the reaction substrate, the inlet and the outlet are provided at a sufficiently wide interval at the outside of the region. Accordingly, the objective lens that is for observing and condensing fluorescence and has a high NA can be disposed in proximity to the microchannel chip, thereby allowing highly sensitive fluorescence detection.

According to this embodiment, even in the case where the substrate holder and the reaction substrate are different in thickness, the sheet 936 can accommodate the step, thereby facilitating design of a substrates and the like.

This embodiment has the same channel structure, and can achieve advantageous effects equivalent to those of Embodiment 3.

### Embodiment 6

The present invention will now be described according to still another embodiment.

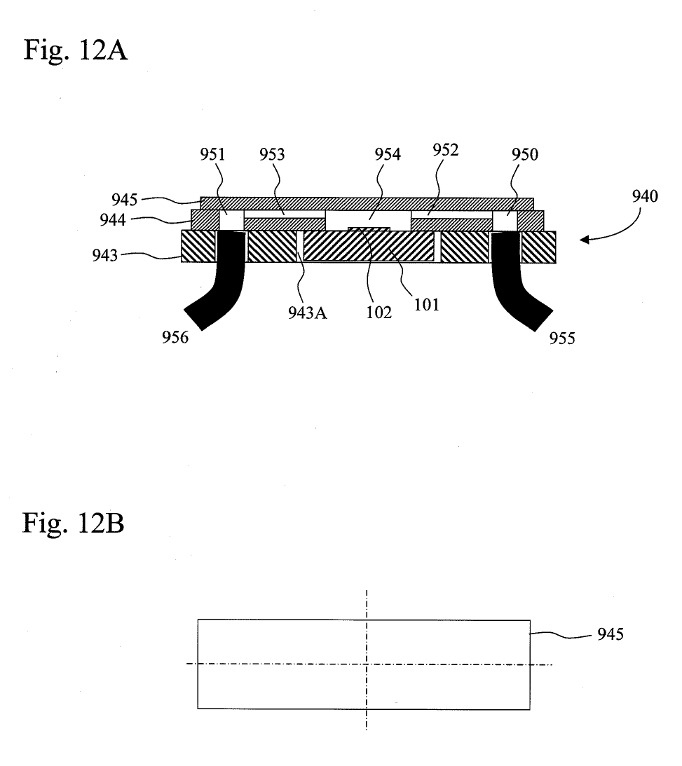

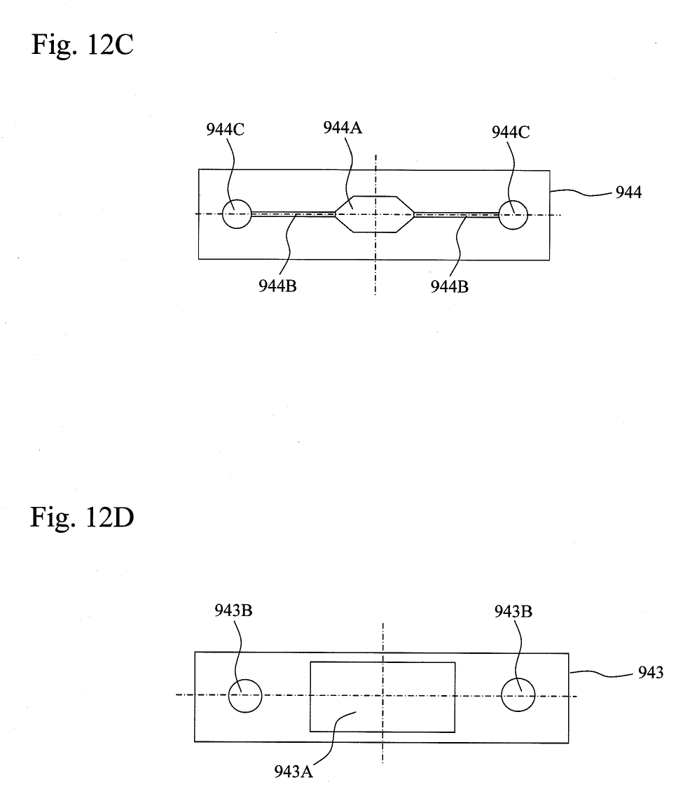

Referring to FIGS. 12A, 12B, 12C and 12D, an example of a microchannel chip 940 according to the present invention will now be described. The reaction substrate 101 equivalent to that of Embodiment 1 (FIG. 1E) is adopted. As shown in FIG. 12A, the microchannel chip of this embodiment includes a substrate holder 943, the reaction substrate 101, a sheet 944 disposed on the upper side of the reaction substrate, and a sheet 945 disposed thereon.

As with Embodiment 4, the reaction spot 102 is formed on the top surface of the reaction substrate 101. The reaction substrate 101 is disposed in a through-hole 943A provided in the substrate holder 943, and supported by the sheet 944 adhering to the substrate holder 943 and the reaction substrate 101. The sheet 945 adheres to the top surface of the sheet 944. The undersurface of the reaction substrate 101 is exposed. A total reflection prism can be caused to optically adhere to or disposed at this exposed part. Accordingly, laser light is introduced to the reaction substrate, and totally reflected by the surface of the reaction spot 102 to form an evanescent field and excite fluorescent substances and the like. The sheets 945 and 944 are made of a transparent material. Fluorescence and the like emitted from the surface of the reaction substrate are observed, condensed and detected from above.

The dimensions of the substrate holder 943 are 26 mm×76 mm. The thickness may be equivalent to the thickness of the reaction substrate, and is defined to be 0.725 mm. As shown in FIG. 12D, the substrate holder 943 includes a through-hole 943A. The dimensions of the through-hole are about 11 mm×11 mm, which accommodates the reaction substrate 101 therein. Through-holes 943B are provided for the sake of the after-mentioned inlet and outlet at positions identical to those of the respective through-holes 944C in the sheet 944.

As shown in FIG. 12C, the sheet 944 has a shape and dimensions equivalent to or slightly smaller than those of the substrate holder 943. The thickness is 100 μm. A through-hole 944A is formed at the center of the sheet 944. The sheet 944 and the reaction substrate are in close contact with each other and covered with the sheet 945, thereby allowing the region of the through-hole 944A to serve as a reaction chamber 954. The through-hole 944A has a size that is larger than the region of the reaction spot 102 but smaller than the entire reaction substrate 101. The reaction spot 102 substantially coincides with the center of the through-hole 944A. The reaction chamber 954 is formed on and above the reaction spot 102. The opposite ends of the through-hole 944A in the sheet 944 communicate with two grooves 944B formed on the top surface, thereby communicating with the respective through-holes 944C at the opposite ends. The grooves 944B have a depth of about 50 μm and a width of about 500 μm. The through-holes 944C at the respective opposite ends have a diameter of 1 mm. This sheet may have a structure equivalent to that of the sheet 904 of Embodiment 3. That is, a structure equivalent to the recess 904A (opening at the undersurface side; with a depth of 50 μm) may be provided, instead of the through-hole 944A, to form a channel.

As shown in FIG. 12B, the sheet 945 is a glass plate that has dimensions equivalent to those of the sheet 944 and a thickness of 100 μm. It is sufficient that the size at least covers the through-holes and the grooves of the sheet 945. Any structure, such as a through-hole or a groove, are not required. Close contact between the sheets 944 and 945 forms channels 952 and 953 corresponding to the respective grooves 944B, and forms an inlet 950 and an outlet 951 corresponding to the respective through-holes 944C in the sheet 944. The inlet 950 and the outlet 951 are configured by the through-hole 944C in the sheet 944 and the through-holes 943B provided in the substrate holder 943.

This forms a channel communicating with the inlet 950, the channel 952, the reaction chamber 954, the channel 953 and the outlet 951. Furthermore, the inlet 950 and the outlet 951 communicate with the inlet tube 955 and the outlet tube 956, respectively, thereby forming a configuration of supplying and discharging required liquid.

As with Embodiments 3 and 4, the microchannel chip includes the inlet, the supply channel, the reaction chamber, the discharge channel and the outlet. The supply channel, the reaction chamber and the discharge channel sequentially communicate with each other, thereby forming a sealed channel. The inlet and the outlet are disposed 20 mm apart from the reaction spot. The inlet and the outlet are about 40 mm apart from each other. This configuration forms a channel that communicates from the inside of a region of the reaction substrate (square having a thickness of about 0.725 mm and a dimension of a side of about 10 mm) to the outside without liquid leakage. Without limitation due to the size of the reaction substrate, the inlet and the outlet are provided at a sufficiently wide interval at the outside of the region. Accordingly, even a substrate with a small size can be used without affecting arrangement of required elements.

The top surface is completely flat. The objective lens that is for observing and condensing fluorescence and has a high NA can be disposed in proximity to the microchannel chip, thereby allowing highly sensitive fluorescence detection. In the case of arranging the total reflection prism, this configuration does not affect the arrangement. Even in the case of total reflection illumination by the objective lens from the undersurface, this configuration does not impede the illumination.

In this embodiment, a glass plate having not been subjected to a process for forming a hole or a groove can be adopted as the sheet 945, which can be easily used, thereby allowing the strength of the chip to be easily improved. This sheet is resistant to a pressure exerted on the channel. Accordingly, deformation of the channel, particularly the surface serving as the observation window below the objective lens, is small, thereby enabling a fluorescence image to be stably measured.

### Embodiment 7

The present invention will now be described according to still another embodiment.

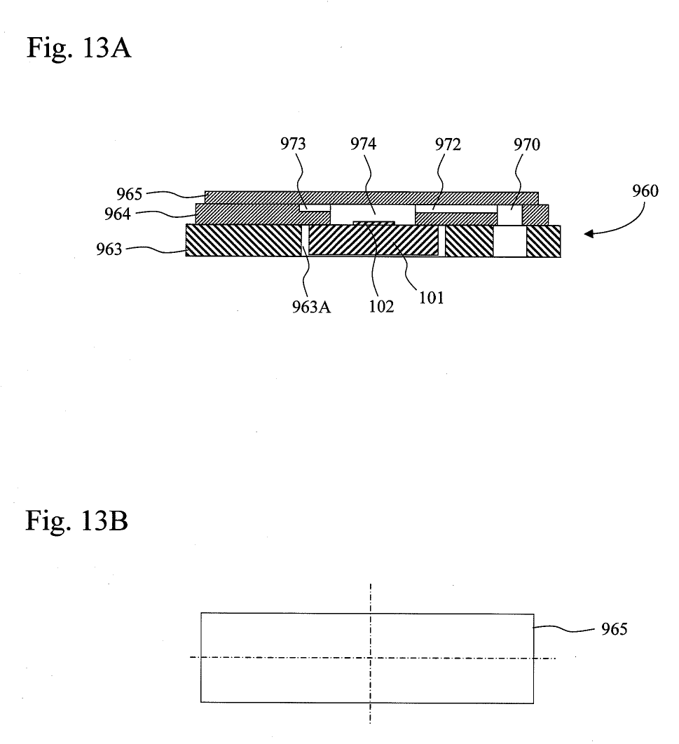

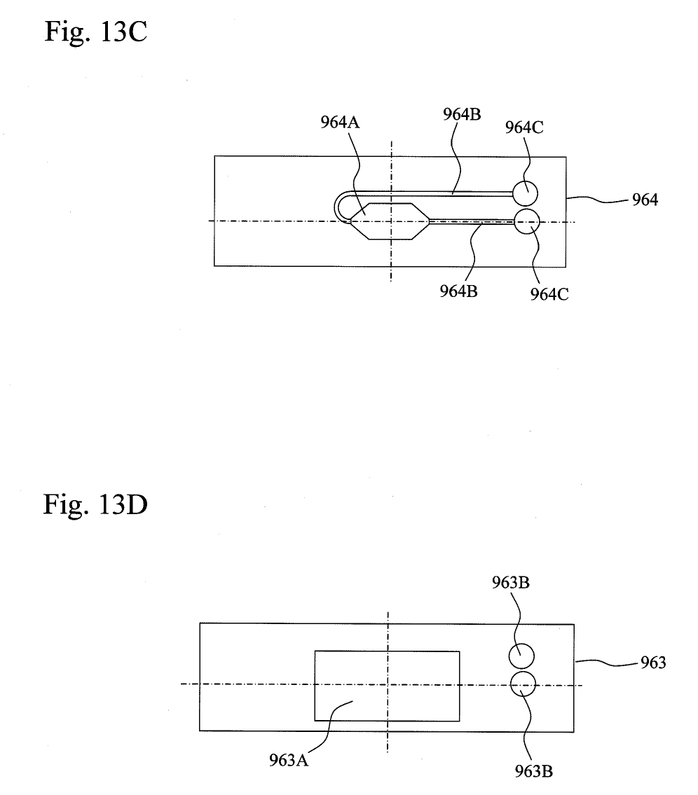

Referring to FIGS. 13A, 13B, 13C and 13D, an example of a microchannel chip 960 according to the present invention will now be described. The reaction substrate 101 equivalent to that of Embodiment 1 (FIG. 1E) is adopted.

As with Embodiment 6, the reaction spot 102 is formed on the top surface of the reaction substrate 101. The reaction substrate 101 is disposed in a through-hole 963A provided in a substrate holder 963, and supported by a sheet 964 adhering to the substrate holder 963 and the reaction substrate 101. A sheet 965 adheres to the top surface of the sheet 964. The undersurface of the reaction substrate 101 is exposed. A total reflection prism can be caused to optically adhere to or disposed at this exposed part. Accordingly, laser light is introduced to the reaction substrate, and totally reflected by the surface of the reaction spot 102 to form an evanescent field and excite fluorescent substances and the like. The sheets 965 and 964 are made of a transparent material. Fluorescence and the like emitted from the surface of the reaction substrate is observed, condensed and detected from above.

The shape of the substrate holder 963 is substantially equivalent to that of the substrate holder 943 of Embodiment 6. As shown in FIG. 13D, the holder includes the through-hole 963A and through-holes 963B. However, the through-holes 963B are provided only on one side.

As shown in FIG. 13C, the sheet 964 has a structure substantially identical to that of the sheet 944 of Embodiment 6. The through-hole 964A, Grooves 964B communicating with the through-hole 964A, and through-holes 964C at the ends of the respective grooves 964B are formed on the sheet 964. The sheet 964 and the reaction substrate are in close contact with each other, and covered with the sheet 965, thereby allowing the region of the through-hole 964A to serve as a reaction chamber 974. The reaction chamber 974 is formed on and above the reaction spot 102. The two through-holes 964C are disposed on the one side of the sheet. Accordingly, a configuration is adopted where one groove 964B changes its orientation by 180 degrees in conformity therewith to communicate with the end of the through-hole 964A.

As shown in FIG. 13B, the sheet 965 is the same as the sheet 945 in Embodiment 6. Close contact between the sheets 964 and 965 forms channels 972 and 973 corresponding to the respective grooves 964B. An inlet 970 and an outlet 971 (not shown) are formed in conformity with the respective through-holes 964C in the sheet 964. The inlet 970 and the outlet 971 are configured by the two through-holes 964C and the through-holes 963B, which correspond to the respective through-hole 964C and are provided in the substrate holder 963.

Thus, a channel communicating with the inlet 970, the channel 972, the reaction chamber 974, the channel 973 and the outlet 971 is formed. Furthermore, a configuration is adopted where the inlet 970 and the outlet 971 communicate with the inlet tube and the outlet tube, respectively, to supply and discharge required liquid.

As with Embodiments 3 and 4, the microchannel chip includes the inlet, the supply channel, the reaction chamber, the discharge channel and the outlet. The supply channel, the reaction chamber and the discharge channel sequentially communicate with each other to form a sealed channel. The inlet and the outlet are disposed 20 mm apart from the reaction spot. This configuration forms a channel that communicates from the inside of a region of the reaction substrate (square having a thickness of about 0.725 mm and a dimension of a side of about 10 mm) to the outside without liquid leakage. Without limitation due to the size of the reaction substrate, the inlet and the outlet are provided at a substantially wide interval at the outside of the region. Accordingly, even a substrate with a small size can be used without affecting arrangement of required elements.

The top surface is completely flat. The objective lens that is for observing and condensing fluorescence and has a high NA can be disposed in proximity to the microchannel chip, thereby allowing highly sensitive fluorescence detection. The undersurface communicates with the inlet tube and the outlet tube, which however disposed sufficiently apart from the position of the reaction spot and concentrated on one side. Accordingly, this configuration does not affect arrangement of the total reflection prism and the like. In the case of total reflection illumination by the objective lens from the undersurface, this configuration can support the illumination in an analogous manner.

In this embodiment, the inlet and the outlet are laid out on the one side, which can secure a wider space on the surface of the chip, thereby allowing the device to be easily configured. Furthermore, the inlet tube and the outlet tube can be easily handled in an integrated manner, which allows the device to be easily configured.

This embodiment exerts advantageous effects equivalent to those of the above embodiments.

### Embodiment 8

The present invention will now be described according to still another embodiment.

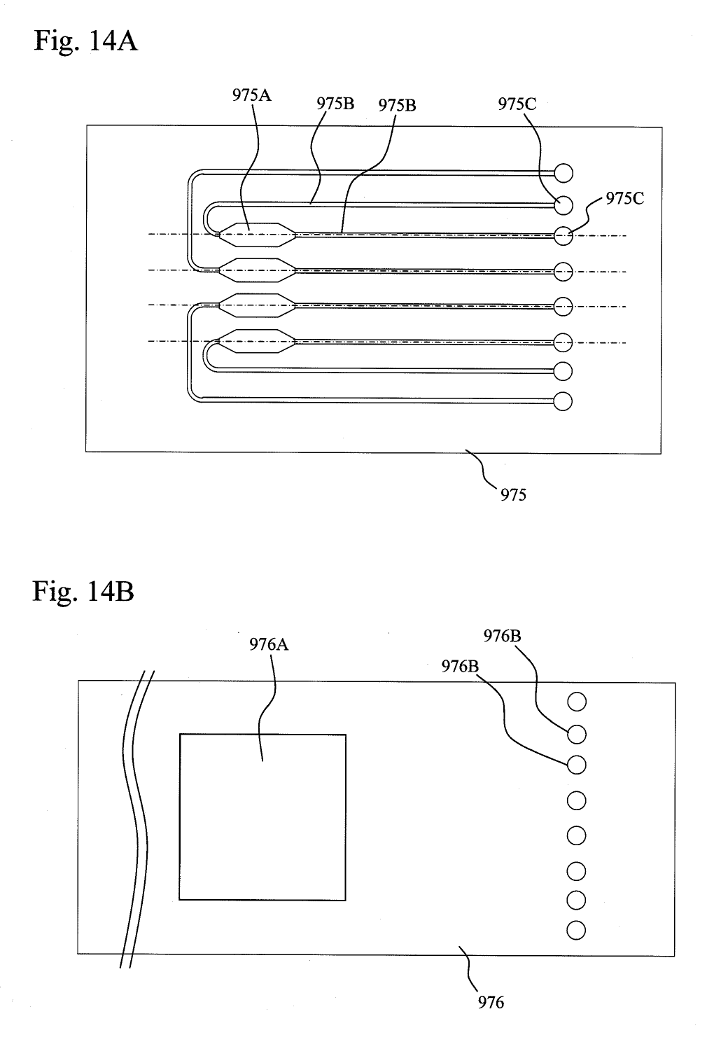

Referring to FIGS. 14A and 14B, an example of a microchannel chip according to the present invention will now be described. The reaction substrate 101 equivalent to that of Embodiment 1 (FIG. 1E) is adopted.

This embodiment adopts the same configuration as in Embodiment 7. Embodiment 7 adopts one set of the inlet, the supply channel, the reaction chamber, the discharge channel and the outlet. However, in this embodiment, four sets are arranged in parallel on the identical reaction substrate. FIG. 14A is a diagram of a sheet 975 and corresponds to FIG. 13C in Embodiment 7. Four sets of channels are provided. Each set includes two through-holes 975C, a through-hole 975A to be a reaction chamber, and two grooves 975B that are provided on the top surface and communicate with the through-holes 975C and 975A. The through-holes 975A have a size of 4 mm broad and 1 mm long, and disposed at intervals of 2 mm. The four through-holes 975A are formed in a region of 4 mm broad and 7 mm long as a whole, and form four reaction chambers on the reaction substrate (square having a dimension of a side of about 10 mm). Change in size of the through-hole 975A can, in turn, change the number of reaction chambers.

Each through-hole 975C has a diameter of 1 mm. Each groove 975B has a depth of about 50 μm and a width of about 500 μm. The through-holes 975C are arranged in the vertical direction at intervals of 2 mm, have an entire dimension in the vertical direction of 15 mm, and are accommodated in the size of the substrate holder of 26 mm×76 mm.

FIG. 14B is a diagram of a substrate holder 976 and corresponds to FIG. 13D of Embodiment 7. This holder includes a through-hole 976A for accommodating the reaction substrate, and through-holes 976B arranged in a manner identical to the respective through-holes 975C in the sheet 975.

The substrate holder 976, the reaction substrate, the sheets 975 and 965 configure the microchannel chip. This allows a plurality of reaction chambers and channels to be configured in one substrate, thereby enabling multiple specimens to be analyzed.

### Embodiment 9

The present invention will now be described according to still another embodiment.

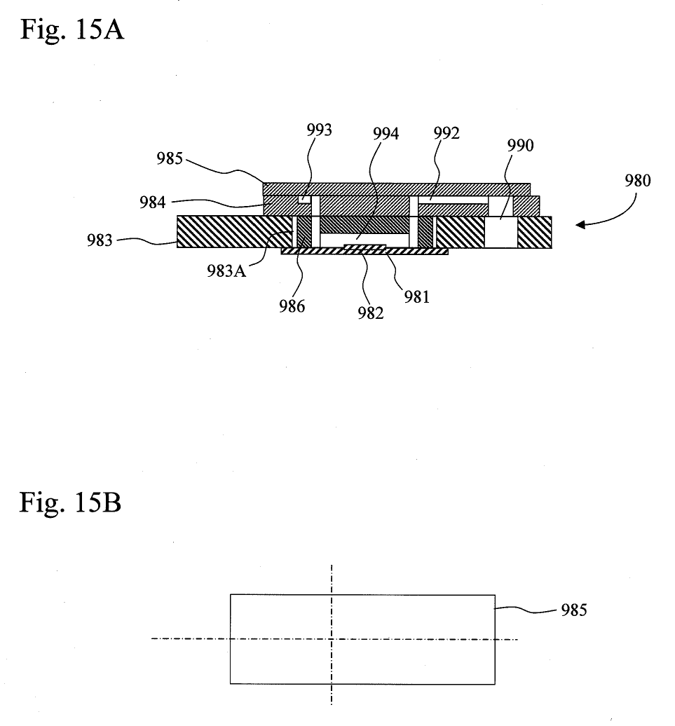

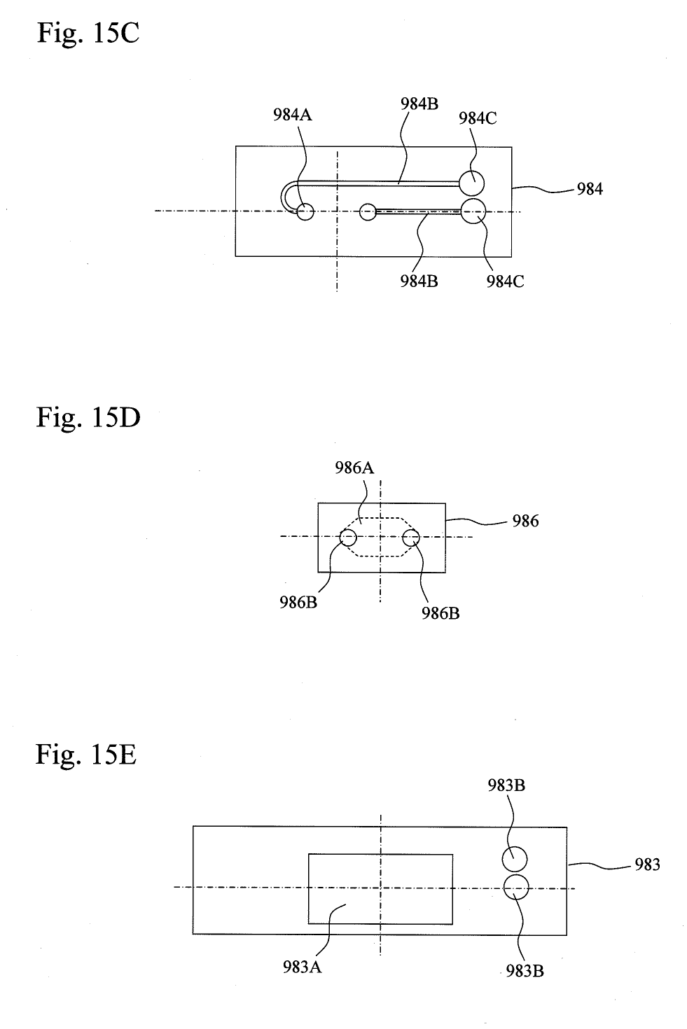

Referring to FIGS. 15A, 15B, 15C, 15D and 15E, an example of a microchannel chip 980 of the present invention will now be described. A square quartz glass substrate having a thickness of about 0.17 mm and a dimension of a side of about 12 mm is adopted as the reaction substrate 981. A reaction spot 982 is formed on the reaction substrate 981 made of quartz glass, in a manner analogous to that of the above embodiment. The microchannel chip 980 is configured by the reaction substrate 981, a substrate holder 983, sheets 984, 985 and 986.

As shown in FIG. 15E, the substrate holder 983 is provided with a through-hole 983A for fixing the reaction substrate 981, and includes through-holes 983B (diameter of 2 mm) to be an inlet and an outlet. The substrate holder 983 has dimensions of 26 mm long and 76 mm broad, and a thickness of 1 mm. The through-hole 983A has dimensions of 10 mm×10 mm. The reaction substrate 981 adheres and is fixed to the undersurface of holder such that the center of the hole coincides with the center of the reaction substrate.

The opening of the through-hole 983A of the substrate holder 983 (thickness of 1 mm) is disposed on and above the reaction substrate 981. The sheet 986 adheres to the reaction substrate 981 so as to cover the opening. As shown in FIG. 15D, the sheet 986 is a PDMS sheet of 9 mm long and 9 mm broad and with a thickness of 1 mm. A recess 986A (hexagon of 2 mm long and 4 mm broad and with a depth of 0.05 mm) is formed at about the center of the undersurface, and includes through-holes 986B having a diameter of 1 mm at the respective ends of the recess.

The sheet 984 is disposed on the top surface of the sheet 986. The sheet 984 adheres to the top surfaces of the sheet 986 and the substrate holder 983. As shown in FIG. 15C, the sheet 984 includes: through-holes 984A (diameter of 1 mm) aligned with the respective through-holes 986B; through-holes 984C (diameter of 2 mm) aligned with the respective through-holes 983B; and grooves 984B that are formed on the top surface to cause the through-holes 984A to communicate with the respective through-holes 984C. The sheet 984 has a size of 26 mm long and 48 mm broad and a thickness of 0.2 mm. The grooves 984B have a depth of 75 μm and width of 400 μm.

The sheet 985 is disposed on the top surface of the sheet 984, and these sheets adhere to each other. As shown in FIG. 15B, a glass plate having the same size as the sheet 984 and a thickness of 0.5 mm is adopted as the sheet 985. The thickness is not necessarily limited thereto. Any size capable of covering the tops of the through-holes and the grooves of the sheet 984 can be adopted.

The recess 986A of the sheet 986 disposed on and above the reaction substrate 981 serves as a reaction chamber 994. The through-holes 986B in the sheet 986, the through-holes 984A in the sheet 984, the sheet 985, and the grooves 984B in the sheet 984 form channels 992 and 993. The through-holes 983B in the substrate holder 983 and the through-holes 984C in the sheet 984 form an inlet 990 and an outlet 991 (not shown). A sealed channel is formed that causes the inlet 990, the channel 992, the reaction chamber 994, the channel 993 and the outlet 991 to sequentially communicate with each other. This configuration forms a channel that communicates from the inside of the reaction substrate 981 to the outside and to further outside without liquid leakage. Without limitation due to the size of the reaction substrate, the inlet and the outlet are provided at the outside of the region. More specifically, the inlet and the outlet may be disposed more than 15 mm apart from the center of the reaction substrate. Accordingly, the objective lens that is for observing and condensing fluorescence and has a high NA can be disposed in proximity to the microchannel chip, thereby allowing highly sensitive fluorescence detection.

In this embodiment, the objective lens for detecting fluorescence is disposed on the undersurface of the reaction substrate. An objective lens with an NA of 1.49 and a magnification of 60 times is adopted. This lens is optically coupled to the reaction substrate by means of oil coupling. Excitation light is incident on the reaction substrate through the objective lens. The reaction spot is irradiated with the light such that the incident angle is the critical angle, thereby performing evanescent excitation. Emitted fluorescence is condensed by the identical objective lens and detected.

This embodiment may adopt a thin reaction substrate, and allows not only prism evanescent irradiation but also objective evanescent irradiation.

This embodiment also enables the channel to be configured by the smaller substrates, thereby allowing reduction in cost of the chip to be realized.

Although the embodiments of the present invention have been described, the present invention is not limited to the above embodiments. Those skilled in the art can easily understand that various modifications can be made within the scope of the present invention described in claims.

### REFERENCE SIGNS LIST

100 . . . microchannel chip, 101 . . . reaction substrate, 102 . . . reaction spot, 103 . . . substrate holder, 104 . . . reaction chamber sheet, 105 . . . channel sheet, 110 . . . inlet, 111 . . . outlet, 112 . . . supply channel, 113 . . . discharge channel, 114 . . . reaction chamber, 120 . . . total reflection prism, 121 . . . incident optical path, 122 . . . emission optical path, 131 . . . packing, 200 . . . analyzer, 211 . . . reagent storing unit, 212 . . . dispensing unit, 213 . . . inlet tube, 214 . . . outlet tube, 215 . . . liquid waste container, 221 . . . laser unit for excitation light, 222 . . . laser unit for excitation light, 223, 224 . . . λ/4 wavelength plate, 225 . . . mirror, 226 . . . dichroic mirror, 227 . . . mirror, 231 . . . objective lens, 232 . . . filter, 233 . . . imaging lens, 234 . . . two-dimensional sensor camera, 235 . . . camera controller, 240 . . . device control computer, 241 . . . analysis computer, 242 . . . output device, 500 . . . microarray chip, 501 . . . reaction substrate, 502 . . . reaction spot, 503 . . . substrate holder, 504 . . . septa, 505 . . . channel sheet, 510 . . . inlet chamber, 511 . . . outlet chamber, 512 . . . supply channel, 513 . . . discharge channel, 514 . . . reaction chamber, 610 . . . supporting member, 611 . . . recess, 622 . . . camera, 621 . . . illumination device, 700 . . . analyzer, 701 . . . inlet needle, 702 . . . outlet needle, 703 . . . electrode, 711 . . . sample tray, 712 . . . washing water bottle, 713 . . . histidine bottle, 714 . . . reserve bottle, 715 . . . four-directional valve, 716 . . . supporting member, 717 . . . two-directional valve, 718 . . . suction device, 720 . . . liquid waste bottle, 741 . . . analysis computer, 742 . . . output device, 743 . . . barcode reader, 900 . . . microchannel chip, 903 . . . substrate holder, 903A . . . recess, 903B . . . reaction substrate holding section, 903C . . . illumination window, 904 . . . sheet, 904A . . . recess, 904B . . . through-hole, 904C . . . groove, 904D . . . opposite ends, 905 . . . sheet, 905A . . . through-hole, 910 . . . inlet, 911 . . . outlet, 912 . . . supply channel, 913 . . . discharge channel, 914 . . . reaction chamber, 920 . . . microchannel chip, 923 . . . substrate holder, 923A . . . through-hole, 930 . . . microchannel chip, 933 . . . substrate holder, 933A . . . recess, 933B . . . reaction substrate holding section, 933C . . . illumination window, 934 . . . sheet, 934B . . . through-hole, 934C . . . groove, 934D . . . opposite ends, 935 . . . sheet, 936 . . . sheet, 936A . . . through-hole, 940 . . . microchannel chip, 943 . . . substrate holder, 943A . . . through-hole, 943B . . . through-hole, 944 . . . sheet, 944A . . . through-hole, 944B . . . groove, 944C . . . through-hole, 945 . . . sheet, 950 . . . inlet, 951 . . . outlet, 952 . . . supply channel, 953 . . . discharge channel, 954 . . . reaction chamber, 955 . . . inlet tube, 956 . . . outlet tube, 960 . . . microchannel chip, 963 . . . substrate holder, 963A . . . through-hole, 963B . . . through-hole, 964 . . . sheet, 964A . . . through-hole, 964B . . . groove, 964C . . . through-hole, 965 . . . sheet, 970 . . . inlet, 971 . . . outlet, 972 . . . supply channel, 973 . . . discharge channel, 974 . . . reaction chamber, 975 . . . sheet, 975A . . . through-hole, 975B . . . groove, 975C . . . through-hole, 976 . . . substrate holder, 976A . . . through-hole, 976B . . . through-hole, 980 . . . microchannel chip, 981 . . . reaction substrate, 982 . . . reaction spot, 983 . . . plate holder, 983A . . . through-hole, 983B . . . through-hole, 984 . . . sheet, 984A . . . through-hole, 984B . . . groove, 984C . . . through-hole, 985 . . . sheet, 986 . . . sheet, 986A . . . recess, 986B . . . through-hole, 990 . . . inlet, 991 . . . outlet, 992 . . . supply channel, 993 . . . discharge channel, 994 . . . reaction chamber.

1. A microchannel chip comprising a reaction chamber, an inlet and an outlet, and a supply channel and a discharge channel that cause the reaction chamber to communicate with the inlet and the outlet, respectively, the microchannel chip further comprising,
a substrate holder including a recess;
a reaction substrate mounted in the recess of the substrate holder;
a first sheet disposed so as to cover the substrate holder and the reaction substrate; and
a second sheet disposed so as to cover the first sheet,
wherein the first sheet includes a through-hole, and the through-hole forms the reaction chamber between the second sheet and the reaction substrate, and
the reaction substrate includes a first surface exposed to the reaction chamber, and a second surface exposed to an outside through an observation window provided at the recess of the substrate holder, and a reaction spot including a microstructure is formed on the first surface of the reaction substrate.

2. The microchannel chip according to claim 1,
wherein the inlet and the outlet are disposed on a surface on an opposite side of a surface on which the observation window of the substrate holder is provided.

3. The microchannel chip according to claim 1,
wherein a channel between the inlet and the outlet is at least 30 mm.

4. The microchannel chip according to claim 1,
wherein grooves are formed on one of the first sheet and the second sheet, and the grooves form the supply channel and the discharge channel between the first sheet and the second sheet.

5. The microchannel chip according to claim 1,
wherein through-holes formed on the second sheet form the inlet and the outlet.

6. The microchannel chip according to claim 1,
wherein the first sheet and the second sheet are made of polydimethylsiloxane (PDMS).

7. The microchannel chip according to claim 1,
wherein the reaction substrate is manufactured using a process of manufacturing a semiconductor.

8. The microchannel chip according to claim 1,
wherein the reaction substrate is made of a plate-like square member having a dimension of a side of 20 mm or less.

9. A method of manufacturing a microchannel chip comprising a reaction chamber, an inlet and an outlet, and a supply channel and a discharge channel that cause the reaction chamber to communicate with the inlet and the outlet, respectively, the method comprising:
preparing a reaction substrate including a first surface on which a reaction spot having a microstructure is formed, and a second surface on an opposite side of the first surface;
disposing the reaction substrate in a recess of a substrate holder;
attaching a first sheet so as to cover the substrate holder and the reaction substrate disposed in the recess of the substrate holder; and
attaching a second sheet so as to cover the first sheet to form the reaction chamber between the second sheet and the reaction substrate,
wherein the reaction spot formed on the first surface of the reaction substrate is exposed to the reaction chamber, and the second surface of the reaction substrate is exposed to an outside through an observation window provided on the recess of the substrate holder.

10. The method of manufacturing a microchannel chip according to claim 9,
wherein the first sheet and the second sheet are made of polydimethylsiloxane (PDMS), and the first sheet and the second sheet adhere to each other using self-adhesion of PDMS.

11. The method of manufacturing a microchannel chip according to claim 9,
wherein the reaction substrate is manufactured using a semiconductor manufacturing process technique.

12. A nucleic acid analyzer comprising a microchannel chip including a reaction substrate; a solution supply system that supplies the microchannel chip with various solutions; a liquid waste collection system that collects various liquid wastes from the microchannel chip; an irradiation system that irradiates the reaction substrate of the microchannel chip with excitation light; and a detection optical system that detects fluorescence from the reaction substrate of the microchannel chip,
wherein the reaction substrate includes a first surface on which a reaction spot is formed, and a second surface on an opposite side of the first surface,
the microchannel chip includes a first main surface, and a second main surface on an opposite side of the first main surface,
an inlet communicating with the solution supply system, and an outlet communicating with the liquid waste collection system are provided on the first main surface, and an observation window for exposing the second surface of the reaction substrate to an outside is provided on the second main surface, and
the detection optical system is disposed on a side of the first main surface of the microchannel chip, and the irradiation system is disposed on a side of the second main surface of the microchannel chip.

13. The nucleic acid analyzer according to claim 12,
wherein a total reflection prism is mounted on the second surface of the reaction substrate,
the excitation light from the irradiation system is guided to the first surface of the reaction substrate through the total reflection prism, and is totally reflected thereon to generate evanescent light, and
a significantly limited region of the reaction spot is irradiated with the evanescent light.

14. The nucleic acid analyzer according to claim 12,
wherein a microstructure is formed on the reaction spot of the reaction substrate for facilitating generation of a localized surface plasmon.

15. A microarray chip comprising: a reaction chamber; an inlet chamber and an outlet chamber; a supply channel and a discharge channel that cause the reaction chamber to communicate with the inlet chamber and the outlet chamber, the microarray chip further comprising:
a substrate holder including a recess;
a reaction substrate mounted in the recess of the substrate holder; and
a sheet disposed so as to cover a surface on an opposite side of a surface on which the recess of the substrate holder is formed,
wherein the recess of the substrate holder includes a through-hole, and the reaction chamber is formed between the reaction substrate exposed through the through-hole and the sheet, and
the reaction substrate includes a first surface exposed to the reaction chamber through the through-hole in the recess of the substrate holder and a second surface exposed to an outside through the recess of the substrate holder, and a reaction spot having a microstructure is formed on the first surface of the reaction substrate.

16. The microarray chip according to claim 15,
wherein openings of the inlet chamber and the outlet chamber are sealed with respective septa.

17. The microarray chip according to claim 15,
wherein control electrodes are provided on the second surface of the reaction substrate, and the chip has a configuration allowing a voltage to be applied to microelectrodes formed on the reaction spot via the control electrodes.

18. The microarray chip according to claim 15,
wherein the reaction substrate is manufactured by a process of manufacturing a semiconductor.

19. A nucleic acid analyzer comprising: a microarray chip that includes a reaction substrate and is for genetic analysis; a solution supply system that supplies the microarray chip with various solutions; a liquid waste collection system that collects various liquid wastes from the microarray chip; an irradiation system that irradiates the reaction substrate of the microarray chip with excitation light; and a detection optical system that detects fluorescence from the reaction substrate of the microarray chip,
wherein the reaction substrate includes a first surface on which a reaction spot is formed, and a second surface on an opposite side of the first surface, and control electrodes for applying a voltage to microelectrodes formed on the reaction spot are provided on the second surface of the reaction substrate,
the microarray chip includes a first main surface, and a second main surface on an opposite side of the first main surface, and an inlet chamber communicating with the solution supply system and an outlet chamber communicating with the liquid waste collection system are provided on the second main surface, and the control electrodes provided on the second surface of the reaction substrate are exposed to an outside at the second main surface, and
the irradiation system and the detection optical system are disposed on a side of the first main surface of the microarray chip.

20. The nucleic acid analyzer according to claim 19,
wherein the inlet chamber and the outlet chamber are sealed with respective septa,
the nucleic acid analyzer further comprises an inlet needle, an outlet needle and electrodes that are movable with respect to the microarray chip, and
the analyzer has a configuration where the inlet needle, the outlet needle and the electrodes are moved toward the microarray chip to thereby allow the inlet needle to pierce the septum with which the inlet chamber is sealed, where the outlet needle pierces the septum with which the outlet chamber is sealed, and the electrodes are connected to control electrodes formed on the second surface of the reaction substrate.

21. A nucleic acid analyzer comprising a microchannel chip including a reaction substrate; a solution supply system that supplies the microchannel chip with various solutions; a liquid waste collection system that collects various liquid wastes from the microchannel chip; an irradiation system that irradiates the reaction substrate of the microchannel chip with excitation light; and a detection optical system that detects fluorescence from the reaction substrate of the microchannel chip,
wherein the reaction substrate includes a first surface on which a reaction spot is formed, and a second surface on an opposite side of the first surface,
the microchannel chip includes a first main surface, and a second main surface on an opposite side of the first main surface,
an inlet communicating with the solution supply system, and an outlet communicating with the liquid waste collection system are provided on the first main surface, and an observation window for exposing the second surface of the reaction substrate to an outside is provided on the second main surface, and
the detection optical system and the irradiation system are disposed on a side of the second main surface of the microchannel chip.

22. The nucleic acid analyzer according to claim 12,
wherein positions of the inlet and the outlet are disposed outside of an external shape of the reaction substrate.

23. A microchannel chip comprising a reaction chamber, an inlet and an outlet, and a supply channel and a discharge channel that cause the reaction chamber to communicate with the inlet and the outlet, respectively, the microchannel chip further comprising:
a reaction substrate including a reaction region on a part of which a reaction spot is disposed;
a substrate holder that is larger than the reaction substrate, and includes a recess supporting the reaction substrate or a through-hole accommodating the reaction substrate;
a first sheet that is larger than the reaction substrate, and includes a through-hole or a recess at a part corresponding to the reaction region; and
a second sheet that adheres to the first sheet and is optically transparent,
wherein the reaction substrate and at least the first sheet form the reaction chamber on a surface of the reaction region,
a channel communicating with the reaction chamber is formed between the first sheet and the second sheet,
the inlet and the outlet are formed at ends of the channel, and
the inlet and the outlet are formed at positions apart from an external shape of the reaction substrate.

24. A microchannel chip, comprising:
a reaction substrate including a reaction region in which a reaction spot is disposed;
a reaction chamber in the reaction region; and
an inlet and outlet that are disposed at positions apart from an external shape of the reaction substrate,
wherein the reaction chamber communicates with the inlet and the outlet through a channel that is not in contact with a surface of the reaction substrate.

25. A microchannel chip, comprising:
a reaction substrate including a reaction region in which a reaction spot is disposed;
a reaction chamber in the reaction region; and
an inlet and an outlet disposed at positions apart from an external shape of the reaction substrate.

26. The microchannel chip according to claim 23, further comprising:
a plurality of the reaction regions on the reaction substrate; and
a plurality of inlets and outlets.

27. The microchannel chip according to claim 23, further comprising
a third sheet that has a size substantially identical to a size of the reaction substrate, includes a through-hole at least at a part of the reaction region, and is disposed between the reaction substrate and the first sheet.

28. The microchannel chip according to claim 23,
wherein a resin having adhesiveness or PDMS is used as the first sheet, the second sheet, or a third sheet.

29. The microchannel chip according to claim 23,
wherein the channel is formed of a recess formed in the first sheet or/and the second sheet.

30. The microchannel chip according to claim 23,
wherein the second sheet is a glass plate.

31. The microchannel chip according to claim 23,
wherein the second sheet is a glass plate having a thickness from 0.02 mm to 0.2 mm.

32. The microchannel chip according to claim 23,
wherein the channel and the inlet and the outlet are formed on the first sheet.

33. The microchannel chip according to claim 23, further comprising
openings at positions corresponding to the inlet and the outlet in the substrate holder, the respective openings being substantially equivalent to the inlet and the outlet.

34. The microchannel chip according to claim 23,
wherein the inlet and the outlet are at least 15 mm apart from the reaction region.

35. The microchannel chip according to claim 23,
wherein the substrate holder and the first sheet are made of a same material, or the first sheet also serves as the substrate holder.

36. The microchannel chip according to claim 23,
wherein the reaction region of the reaction substrate is illuminated by evanescent light.
